(19) United States
(12) Patent Application Publication
(10) Pub. No.: US 2026/0350534 A1
(43) Pub. Date: Nov. 5, 2026

(54) CONTROLLING THE PRODUCTION OF A CHEMICAL PRODUCT

(71) Applicants: BASF SE, Ludwigshafen am Rhein (DE); BASF COATINGS GMBH, Münster (DE)

(72) Inventors: Victor Kaupe, Ludwigshafen (DE); Henning Schwabe, Ludwigshafen (DE); Dennis Haardt, Ludwigshafen (DE); Andreas Wollny, Ludwigshafen (DE)

(21) Appl. No.: 19/488,894

(22) PCT Filed: May 22, 2024
(86) PCT No.: PCT/EP2024/064069

§ 371 Date: Dec. 1, 2025

(30) Foreign Application Priority Data
Jun. 2, 2023 (EP) 23177008.2

(51) Int. Cl. G06Q 10/087; G05B 19/418

(52) U.S. Cl. CPC G06Q 10/08726; G05B 19/4183; G06Q 10/0877

(57) ABSTRACT

Disclosed herein are methods, apparatuses, systems and computer-elements for controlling the production of a chemical product by a chemical production based on a quantity of chemical product consumed at a consumption location. Controlling the production may include producing further chemical product if the quantity of the chemical product present at the consumption location has reached or has fallen below a predefined threshold. The produced further chemical product may be associated with a chemical product passport allowing retrieval of chemical product data associated with the further chemical product via a decentral network.

### TECHNICAL FIELD

The invention relates to methods, apparatuses, systems and computer-elements for controlling the production of a chemical product by a chemical production.

### TECHNICAL BACKGROUND

Vendor managed inventory (VMI) is an inventory management practice in which a supplier of goods, such as a chemical product producer, is responsible for optimizing the inventory held by his customer, such as a discrete product producer or an upstream participant of the supply chain. This can prevent stocking undesired inventories and hence can lead to an overall cost reduction.

The supply of goods from the supplier to the customer may be accompanied by information associated with the supplied goods, for example to meet regulatory requirements. For instance, in automotive supply chains chemical companies provide standardized information using the International Chemical Product Data System (IMDS). Such system allows to collect data along the entire automotive supply chain. Participants in the automotive supply chain register with the IMDS service and maintain product entries in the central database as provided and hosted by a third-party provider.

Systems like IMDS are static regarding data, prone to error and cumbersome in handling or maintenance. Owing to the highly specific and centralized setup of such systems, exchange and sharing of data associated with chemical products supplied in the context of vendor managed inventory is laborious. Hence, there is a need to control the production of chemical products based on the consumption of the chemical product by an upstream participant and to simplify exchange and sharing of data on such produced chemical products.

### SUMMARY

In an aspect, the disclosure relates to a method for controlling the production of a chemical product by a chemical production, said method comprising:
(a) producing the chemical product from one or more materials using the chemical production and providing the produced chemical product to a consumption location,
(b) gathering data being indicative of the quantity of the chemical product at the consumption location and comparing the gathered data to a predefined minimum threshold,
(c) in accordance with the determination that the monitored quantity of the chemical product has reached or has fallen below the predefined minimum threshold, triggering production of further chemical product,
(d) receiving a request to provide a decentral identifier associated with chemical product data of the produced further chemical product and preferably a data owner;
(e) in response to the request, generating a chemical product passport including the decentral identifier and data related to the chemical product data and assigning a physical identifier connected to the produced further chemical product to the provided decentral identifier.

In a further aspect, the disclosure relates to an apparatus for controlling the production of a chemical product by a chemical production, the apparatus comprising:
a chemical production configured to produce the chemical product and the further chemical product from the one or more inbound material(s) and to provide the produced chemical product and further chemical product to a consumption location,
a monitoring unit configured to gather data being indicative of the quantity of the chemical product at the consumption location and to compare the gathered data to a predefined minimum threshold,
a triggering unit configured to trigger the production of further chemical product if the gathered data being indicative of the quantity of the chemical product has reached or has fallen below the predefined minimum threshold,
a collector configured to collect chemical product data associated with the further chemical product,
a chemical product passport generator configured to generate a chemical product passport by receiving a request to provide at least the decentral identifier linked to chemical product data associated with the further chemical product and in response to the request, generate the chemical product passport including the decentral identifier and data related to the chemical product data,
an assignor configured to assign a physical identifier connected to the produced further chemical product to the decentral identifier included in the generated chemical product passport associated with the produced further chemical product.

In a further aspect the disclosure relates to a computer element, such as a computer readable storage medium, a computer program or a computer program product, comprising instructions, which when executed by a computing node or a computing system, direct the computing node or computing system to carry out the steps of the methods as disclosed herein.

In a further aspect the disclosure relates to a computer element, such as a computer readable storage medium, a computer program or a computer program product, comprising instructions, which when executed by the apparatuses or systems as disclosed herein, direct these apparatuses or systems to carry out steps these apparatuses or systems are configured to execute.

Any disclosure, embodiments and examples described herein relate to the methods, the apparatuses, and computer elements lined out above and below. Advantageously, the benefits provided by any of the embodiments and examples equally apply to all other embodiments and examples.

### Embodiments

The methods, apparatuses and computer elements disclosed herein allow to control the production of chemical products based on data related to the current quantity of chemical products supplied to a customer by matching the chemical production to the needs of the customer. This results in decreased storage costs for both the supplier and the customer while ensuring a sufficient supply of chemical products to the customer. Moreover, this also allows to reduce the overall production and storage costs of the upstream participants due to the control of the supply of chemical products such that excessive storage of provided chemical products is not necessary while at the same time ensuring that the production of the upstream participant is not negatively influenced.

The methods, apparatuses and computer elements disclosed herein further provide an efficient, secure and robust way for sharing or exchanging data across different participant nodes in chemical value chains. Use of a chemical product passport including a decentral identifier and associated chemical product data allows for simplified and customizable data sharing or exchange from chemical industry to chemical supply chain participants. This way, a more reliable and efficient further processing of supplied chemical product by upstream participants of the chemical supply chain can be achieved, while the chemical product data remains in the ownership of the chemical supplier supplying the upstream participant. By combining the chemical product data directly with the decentral identifier and optionally one or more authentication mechanisms more reliable and secure data sharing and exchange can be provided. By further including one or more authorization mechanisms, the data sharing or exchange can be conducted in a more flexible manner with multiple data consuming services from different participants of the chemical supply chain accessing the chemical product data.

It is an object of the present invention to control the production of chemical products based on the consumption of the chemical products by a downstream participant (e.g. a consumer of the chemical products) of a supply chain associated with or including the chemical products and to simplify exchange and sharing of data on produced chemical products while allowing the data owner of such data, e.g. the chemical product producer, to control access to such data by downstream participants using such produced chemical products. This way, the chemical product data can be exchanged in a simple yet controlled manner with downstream participants, allowing the downstream participants to use such data for the production of further products using the received chemical product(s).

These and other objects, which become apparent upon reading the following description, are solved by the subject matters of the independent claims. The dependent claims refer to preferred embodiments of the invention.

In the following, embodiments of the present disclosure will be outlined by ways of examples. It is to be understood that the present disclosure is not limited to said embodiments and/or examples.

In an embodiment, material may be one or more chemical materials including intermediate products that are used in the production of the chemical product. In one embodiment, the material may be an indiscrete material, e.g., may be a continuous volume of solid or liquid material in case.

In one embodiment, the inbound material may a chemical raw material or a chemical material. A chemical raw material be a material that is used as an educt or starting material in a production process. It may be a virgin material or a reused material, e.g., a material having already gone through a production and use cycle. A virgin material may comprise newly extracted raw material, such as material that has not undergone a previous production-and-use cycle, e.g. has not been processed and/or used. A reused material may be a material that has already undergone a production-and-use cycle. For example, a reused material may be a material that has undergone, after use of the material, a treatment to prepare it for reuse. This may entail a processing step, e.g., recycling and/or other treatment steps, e.g., cleaning or the like. A recycled material is an example of a reused material. It may be a material having undergone, after use of the material, one or more processing steps. The processing steps may be such steps that enable the material to be introduced into a production step as a raw material. A chemical material may be a chemically processed material, such as a raw material having undergone at least one chemical reaction, for example an intermediate material used in a further production step.

In an embodiment, the chemical product may be a chemical product obtained from at least one chemical reaction. The chemical product may include natural chemical products. Natural chemical products may include any chemical product that is produced by nature without human interaction or intervention, i.e. any unprocessed chemical substance that is found in nature, such as chemicals from plants, micro-organisms, animals, the earth and the sea or any chemical substance that is found in nature and extracted using a process that does not change its chemical composition. Natural chemical products may include biologicals like enzymes as well naturally occurring inorganic or organic chemical products. Natural chemical products may be isolated and purified prior to their use or they can be used in unisolated and/or unpurified form. Chemical products may be synthetic chemical products. Synthetic chemical products may include chemical products produced with human interaction or intervention. Synthetic chemical products may be produced with the same chemical reactions occurring in nature or with different chemical reactions. Chemical products may be any inorganic or organic chemical product obtained by reacting inorganic and/or organic chemical reactants. The inorganic and organic chemical reactants may be natural chemical products or may be synthetic chemical products. Chemical reactions may include any chemical reaction commonly known in the state of the art in which the reactants are converted to one or more different chemical products. Chemical reactions may involve the use of catalysts, enzymes, bacteria, etc. to achieve the chemical reaction between the reactants. The chemical product may include a raw material. The chemical product may include a chemical material produced by reacting at least two raw materials. The chemical product may include a component. The chemical product may include a component assembly.

In an embodiment, gathering may include retrieving or receiving data.

In an embodiment, defined quantity may indicate the amount of chemical product supplied to the consumption location. The defined quantity may correspond to the total amount of chemical product supplied to the consumption location. The defined quantity may correspond to the amount of chemical product supplied to the consumption location in each delivery. For example, the amount of chemical product may correspond to the total amount associated with each delivery of chemical product to the consumption location. The defined quantity may relate to data associated with the total amount of chemical product supplied to the consumption location or with the total amount of each delivery of chemical product to the consumption location.

In an embodiment, consumption location may refer to a production, such as a chemical production or a chemical to discrete production, where chemical products are provided to and where the provided chemical products are used as inbound chemical materials to produce further chemical products or discrete products. The consumption location may be operated by a downstream participant of the supply chain associate with or including the chemical product. Discrete products may be any products associated with a distinct physical unit. Discrete manufacturing in contrast to process manufacturing uses such discrete products to assemble other discrete products. Chemical production in contrast uses process manufacturing where material(s) are mixed and chemically converted to chemical product(s).

In an embodiment, the predefined minimum threshold may correspond to data related to the total quantity of chemical product which should not be fallen short of to avoid consumption bottlenecks at the consumption location. The predefined minimum threshold quantity may be a fixed value for each chemical product or may vary according to production capacity. The predefined minimum threshold may be determined using data related to the scheduled production orders at the consumption location and/or historical data on quantities of chemical product used at the respective consumption location.

In an embodiment, triggering production of the further chemical product may be performed by an operating system associated with the chemical production by determining chemical production data and controlling the production of the further chemical products based on the determined production data. The operating system may be configured to determine the production data upon receiving an indication that the monitored quantity of the chemical product provided to the consumption location has fallen below the predefined minimum threshold associated with the chemical product. The operating system may be configured to monitor the quantity of the chemical product provided to the consumption location and to determine whether the monitored quantity has fallen below the predefined minimum threshold. In response to said determination, the operating system may be further configured to determine the production data.

In one embodiment, the further chemical product may be the same chemical product already provided to the consumption location. However, the chemical product already provided to the consumption location and the further chemical product may differ in that the further chemical product represents another batch of the chemical product previously provided to the consumption location. The further chemical product may be produced based on chemical production data, for example a bill of material or a recipe associated with the chemical product previously provided.

In embodiment, physical identifier (also referred to as physical identifier element hereinafter) may refer to any physical arrangement that allows to uniquely identify the chemical product. The physical identifier may be any identifier for the chemical product, such as a batch number, a LOT number and/or an order number assigned to the chemical product. The LOT number may be assigned to the chemical product on production. The order number may be assigned to a transfer of a certain quantity of chemical product to the consumption location. The order number may relate to the chemical product producer identity and the consumption location entity. The physical identifier may comprise a passive or active element, e.g. QR-code, RFID-tag, but is not limited thereto. The physical identifier may include markers embedded in the chemical product. The physical identifier may be associated with or linked to the decentral identifier. This way, the physical entity of the further chemical product may be linked to a digital twin of said further chemical product.

In an embodiment, the decentral identifier may comprise any unique identifier uniquely associated with the chemical product data of the produced further chemical product, and optionally the data owner. The decentral identifier may connect the physical entity of the further chemical product to the digital twin of said further chemical product. The decentral identifier may uniquely identify the further chemical product and/or its digital twin within a decentral network. The decentral identifier may include one or more Universally Unique Identifier(s) (UUID(s)) or Digital Identifier(s) (DID(s)). The one or more DID(s) and/or UUID(s) may be associated with the digital twin and/or the chemical product data of the produced further chemical product. The one or more DID(s) and/or UUID(s) may further be associated with the further chemical product. The decentral identifier may be generated by the data owner or on behalf of the data owner of the chemical product data of the produced further chemical product. The decentral identifier may include authentication information. Via the decentral identifier and its unique association with the chemical product data of the produced further chemical product (and hence with the further chemical product) and optionally the data owner, access to said data or parts thereof, may be controlled by the data owner. Hence, the decentral identifier allows the data owner of the chemical product data to control access to such chemical product data. This contrasts with central authority schemes, where identifiers are provided by such central authority and access to data is controlled by such central authority. Decentral in this context refers to the usage of the decentral identifier(s) in implementations as controlled by the data owner. The decentral identifier may include or be associated with one or more identifier(s) used in a decentral network and allowing for data exchange via the decentral network. For instance, the decentral identifier may include or be associated with identifier(s) of chemical product data sets contained within the chemical product data. Any combination of UUID(s) and DID(s) may be possible. For instance, the decentral identifier may be a DID while the data set identifier(s) may be UUID(s). In another instance, the decentral identifier and the data set identifier(s) may be UUIDs. Data exchange may include discovery of the decentral identifier and optionally identifier(s) associated with said decentral identifier for participant nodes of the decentral network, authentication of participant nodes of the decentral network and/or authorization of data transfers via a peer-to-peer communication between participant nodes of the decentral network. The decentral identifier may be associated with any participant of the supply chain including intermediate chemical products manufacturer, intermediate part manufacturer, component manufacturer or component assembly manufacturer. The decentral identifier may be associated with a machine, a system, or a device used for producing the basic substance, the chemical product, the intermediate product, the component, or the component assembly, or a collection of such machine(s), device(s) and/or system(s).

In an embodiment, the data owner includes an entity generating the chemical product data and/or the data owner is the data owner of the chemical product data and/or of the data set(s) contained in the chemical product passport. The data generating node may be coupled to the entity owning the physical entity of the chemical products from or for which data is generated. The data, in particular the chemical product data, may be generated by a third-party entity on behalf of the entity owning the physical entity of the chemical products from or for which data is generated. The data owner may be the chemical product producer. The data owner may hence directly or indirectly own the chemical product data. The chemical product data may be stored in a data base of or associated with the data owner. The chemical product data may be stored in a data base of or under control by the data owner. The chemical product data may be stored in a data base accessible by the data owner. The data owner may control access to the chemical product data stored in such data base, for instance via a decentral data providing network node associated with the data owner. The chemical product data may be associated with the data owner. The data owner may be the owner of the chemical product data or the chemical product data owner. In this sense, the data owner is to be construed broadly as the entity having access to the chemical product data and controlling access by decentral data consuming network nodes of the decentral network to the chemical product data.

In an embodiment, the chemical product passport may comprise a digital representation of chemical product data. The digital representation may include a representation for accessing the chemical product data or a part thereof, such as a locator or pointer to the chemical product data. The digital representation may include a representation of chemical product data or parts thereof. The chemical product passport may include data related to the chemical product data, the public key and the decentral identifier. The data related to the chemical product data may include the digital representation of the chemical product data. If the digital representation of the chemical product data includes a representation for accessing the chemical product data or part thereof, such as a locator to the chemical product data or parts thereof, the chemical product data may be stored on a dedicated storage, for example a dedicated storage owned or controlled by the data owner, and may be accessed via a decentral consuming network node using said locator. Access to such dedicated storage may be controlled by the data owner, for example via a decentral providing network node. Use of a locator within the chemical product passport allows the data owner to retain the control over the chemical product data because appropriate authorization and authentication is required to access said data. This allows to openly share the contents of the chemical product passport(s), for example on public web platforms, without having to disclose the chemical product data associated with the chemical product passport via the decentral identifier. Thus, transparency about existing chemical product passports can be provided while at the same time ensuring the required level of confidentiality of the chemical product data associated with said chemical product passports.

In an embodiment, the chemical product passport may comprise the chemical product data. Hence, the chemical product passport may be regarded as a digital twin of the chemical product. The digital twin of the chemical product may be a digital representation of a physical entity of the chemical product with a defined semantic description of said physical entity of the chemical product. The digital twin of the physical entity of the chemical product is hence a digital version of said physical entity. Once created, the digital twin may be used to represent the physical entity of the chemical product in a digital representation of a real-world system. The digital twin may be uniquely linked to the physical chemical product via at least the decentral identifier. The digital twin may be created such that it is identical in form and behavior of the corresponding chemical product. The digital twin may contain one or more data sets. Each data set may contain defined chemical product data. Each data set may be associated with the decentral identifier. Each data set may further be associated with a data set identifier. This allows to uniquely identify each data set contained in the digital twin by using the data set identifier associated with said data set. The digital twin may comprise the decentral identifier, the data set(s) and data set identifier(s) associated with the data set(s). The digital twin may further contain a chemical product identifier. The chemical product passport and hence the decentral identifier may be linked to a digital representation of the chemical product data included in the chemical product passport. The digital representation may be regarded as an access element providing access to the chemical product passport. The digital representation may include a representation for accessing the chemical product data or a part thereof, such as a locator or a pointer to the chemical product data. The digital representation may further include the decentral identifier. The digital representation may be stored in a repository of the decentral network and may be accessible by decentral consuming network nodes while the chemical product passport may be stored in a data base associated with or under control of or accessible by the data owner of the chemical product passport. The decentral consuming network nodes may use the decentral identifier and representation for accessing the chemical product data or a part thereof to request access to such data at a decentral providing network node. This way, transparency about existing chemical product passports can be provided via the digital representations while allowing the data owner of the chemical product passport to control access to the included chemical product data.

In an embodiment, a computing node may refer to any device or system that includes at least one physical and tangible processor, and a physical and tangible memory capable of having thereon computer-executable instructions that are executed by a processor. Computing nodes may, for example, be handheld devices, production facilities, sensors, monitoring systems, control systems, appliances, laptop computers, desktop computers, mainframes, data centers, or even devices that have not conventionally been considered a computing node, such as wearables (e.g., glasses, watches or the like). The memory may take any form and depends on the nature and form of the computing node.

In an embodiment, the chemical product is a chemical intermediate product or a chemical end product. Chemical intermediate product may refer to a chemical product usable as inbound material in further chemical production processes to produce a chemical product being different from the chemical intermediate product. Chemical end product may refer to a product usable by an end user, e.g. a product which is not associated with any further production processes.

In an embodiment, the chemical product is a coating material. Coating materials may include liquid, paste-like or powdery materials which, when applied to at least part of the surface of a substrate, produce a coating with protective, decorative and/or other specific properties (see also DIN EN 971-1:1996-09). Substrates may include metal substrates, plastic substrates and mixtures thereof. The substrates may be pretreated or may comprise at least one coating layer. The coating materials may be applied using commonly known application techniques, such as dipping, bar coating, spraying, rolling or the like. Machines may be stationary machines or movable machines. Stationary machines may include air conditioning devices, power units (nuclear, coal, natural gas, oil, wind, water, solar thermal, geothermal), generators, pumps, hydraulic power units, wind turbines, transformer stations, thermal heat pumps, and compressors. Movable machines may include vehicles. Vehicles may include motor vehicles. Examples of motor vehicles may include motor-cycles, cars, trucks, buses, vans, minivans, ATV (all-terrain vehicles) and mobility scooters for disabled people. Vehicles may include railed vehicles. Examples of railed vehicles may include trains and trams. Vehicles may include watercraft vehicles. Examples of watercraft vehicles may include ships, boats and underwater vehicles. Vehicles may include amphibious vehicles. Examples of amphibious vehicles may include screw-propelled vehicles and hovercraft. Vehicles may include aircrafts. Examples of aircrafts may include airplanes, helicopters and aerostats. Vehicles may include spacecraft. The stationary or movable machines may be driven by spark-ignited or self-ignition engines, two-or four stroke engines, electrical engines, fuel cells or combinations thereof (hybrid engines).

The coating material may be selected from the group consisting of coating materials and coating material components. Coating materials may be selected from electrocoating materials, primer materials, primer-surfacer materials, filler materials, putty materials, basecoat materials, clearcoat materials or tinted clearcoat materials. For instance, the coating material may be a primer material. In another instance, the coating material may be an electrocoating material. In yet another instance, the coating material may be a clearcoat material. Coating material components may be selected from hardener compositions, additive compositions, thinners, reducers, spot blender compositions, pigment pastes or binder compositions. For instance, the coating material component may be a hardener composition. In another instance, the coating material component may be a binder composition. In yet another instance, the coating material component may be a thinner. In yet another instance, the coating material component may be a reducer. In yet another instance, the coating material component may be a spot blender composition. In yet another instance, the coating material component may be a pigment paste. In yet another instance, the coating material component may be an additive composition.

In an embodiment, the produced chemical product is present within a packaging unit. The packaging unit may be a reusable packaging unit. The packaging unit may be a single use packaging unit (e.g. a packaging unit which may not be reused). The packaging unit may be configured to store the chemical product. The packaging unit may be configured to allow transport of the chemical product. The packaging unit may be made of paper, plastic, metal, or combinations thereof. For example, the packaging unit may be a reusable metal intermediate bulk container. Use of reusable packaging units avoids waste associated with used packaging units, hence reducing the environmental footprint associated with the production and use of the chemical product.

In an embodiment, the chemical production is a chemical production network. The chemical production network chemical production network may include multiple interlinked processing steps. The chemical production network may be an integrated chemical production network with interrelated production chains. The chemical production network may include multiple different production chains that have at least one intermediate product in common. The chemical production network may include multiple stages of the chemical value chain. The chemical production network may include multiple production chains that produce from one or more inbound material(s) as input chemical products as output. The chemical production network may include multiple tiers of a chemical value chain. The chemical production network may include a physically interconnected arrangement of production sites. The production sites may be at the same location or at different locations. In the latter case, the production sites may be interconnected by means of dedicated transportation systems such as pipelines, supply chain vehicles, like trucks, supply chain ships or other cargo transportation means.

In an embodiment, a defined quantity of chemical product is provided to the consumption location. The defined quantity may include a defined amount of the produced chemical product or a measured amount of the produced chemical product. The amount may be denoted in any suitable unit, such as liter, kg, tons, grams, mol, etc. The measured quantity may be provided by a sensor associated with the material storage storing the produced chemical product or the plant producing the chemical product. The measured quantity may be provided to a packaging unit. The providing system may be a pipeline continuously providing the chemical product or a filling system intermittently providing the chemical product. The defined amount of produced chemical product may be associated with the packaging unit used to package the chemical product. For instance, the defined amount may correspond to the amount the packaging unit is configured to hold.

In an embodiment, providing the produced chemical product to the consumption location includes feeding the produced chemical product to a product storage of the consumption location or feeding the produced chemical product to a plant associated with the consumption location. The produced chemical product may be continuously feed to the plant, for example via a pipeline connecting the product storage with the plant. The produced chemical product may be intermittently fed to the plant, for example via a filling system connected with the plant.

In an embodiment, data being indicative of the quantity of the chemical product is gathered at the consumption location via at least one sensor device. The data may be gathered during storage of the chemical product within a product storage of the consumption location storing the chemical product. The data may be gathered during use of the chemical product within the plant of the consumption location to produce further chemical or discrete products. Use of sensor devices attached to packaging units containing the chemical product allows to monitor the consumption of the chemical product in real time. This allows to ensure that a sufficient amount of chemical product is always available at the consumption location since time delays during determination of the current amount of chemical product available at the consumption location are minimized.

The sensor device may be configured to provide the data being indicative of the quantity of the chemical product. The quantity of the chemical product may include the quantity of the chemical product present within a respective packaging unit. Data being indicative of the quantity of the chemical product may include data being indicative of the amount of product present within the respective packaging unit. Data being indicative of the amount may include the fill level of the product within the packaging unit. Data being indicative of the amount may include acoustic signal(s) detected by the sensor device and being indicative of the amount. Data being indicative of the quantity of the chemical product may include data being indicative of whether the chemical product and hence the associated packaging unit has been used for production of further products. For instance, the sensor device may be configured to detect a movement of the packaging unit from the product storage to a production plant and said movement detection may trigger provision of data indicating that said product has been consumed.

The sensor device may be present on the respective packaging unit containing the chemical product. The sensor device may be physically connected to said packaging unit. The sensor device may be physically connected to the inside of said packaging unit. The sensor device may be physically connected to the outside of said packaging unit. The sensor device may be present within the chemical product contained within said packaging unit, e.g. the sensor device may not be physically connected to said packaging unit.

In an embodiment, gathering data being indicative of the quantity of the chemical product at the consumption location includes
gathering via a computing interface data from one or more sensor device(s) associated with the chemical product, said data including data being indicative of the quantity of the chemical product and a chemical product identifier associated with the chemical product,
determining data related to the remaining quantity of the chemical product using the gathered sensor device data.

The sensor device(s) may be associated with the packaging unit of the chemical product. Each packaging unit may comprise a sensor device providing data being indicative of the quantity of the chemical product present within the respective packaging unit. The data may be gathered from the sensor device(s) at predefined time intervals. The sensor device(s) may be configured to provide said data upon detecting a predefined trigger. For instance, the sensor device(s) may be configured to provide said data upon detecting movement of the packaging unit from the product storage to a production plant. This avoids unnecessary data transfer within the network and allows to prolong the service life of battery powered sensor device(s).

The data gathered from the sensor device may further include data being indicative of the consumption location. This ensures assignment of the data gathered from the sensor devices to the appropriate consumption location and hence allows to monitor the quantity of a chemical product at a plurality of different consumption locations.

Data related to the remaining quantity of the chemical product at the consumption location may correspond to the sum of all the data being indicative of the quantity of the chemical product gathered from at least part of the sensor device(s). Determining the data related to the remaining quantity may include determining data being indicative of the amount of product present within the respective packaging unit associated with a sensor device from which data has been gathered. Data being indicative of the amount may include the fill level of the product within the packaging unit. Hence, determining the data related to the remaining quantity may include determining the fill level of the chemical product within at least part of the packaging units present at the consumption location. The sum of all determined fill levels may correspond to the data related to the remaining quantity. Use of data gathered from sensor devices allows to determine the data related to the remaining quantity in real time or near-real time without having to rely on consumption data gathered by an operation system of the plant(s) consuming the chemical product. The data related to the remaining quantity may be associated with a chemical product identifier associated with the chemical product. This allows to associate the data related to the remaining quantity with a particular chemical product. The data related to the remaining quantity may be associated with a consumption location identifier. This allows to associate the data related to the remaining quantity with a particular consumption location.

In another embodiment, gathering data being indicative of the quantity of the chemical product at the consumption location includes
gathering via a computing interface data related to the amount of chemical product consumed at the consumption location,
gathering data related to the amount of chemical product provided to the consumption location, and
determining data related to the remaining quantity of the chemical product using the gathered data.

The data related the amount of chemical product consumed at the consumption location may include the amount of consumed chemical product. The amount of consumed chemical product may include the amount consumed at one or more plant(s) of the consumption location. The data related to the amount of consumed chemical product may be gathered by an operating system associated with the plant consuming said chemical product. Hence, the operating system may be configured to track inbound materials and associated amounts used during processes performed within said plant. The inbound materials may include the chemical product. The gathered data may be provided to a storage environment, such as a database. The storage environment may be accessible via a computing interface.

Data related to the amount of chemical product provided to the consumption location may be gathered by an operating system associated with the chemical production producing said chemical product. For instance, amounts of produced chemical product and amounts provided to a particular consumption location may be gathered by said operating system and may be stored within a storage environment, such as a database. The chemical product may be associated with a chemical product identifier to allow identification of the chemical product via said identifier. The consumption location may be associated with a consumption location identifier to allow identification of the consumption location via said identifier.

In an embodiment, triggering production of further chemical product includes generating chemical production data and producing further chemical product using the generated chemical production data. The chemical production data may be generated based on a chemical product identifier associated with the chemical product. The chemical production data may further be generated based on a consumption location identifier associated with the consumption location. Use of the consumption location identifier allows to generate chemical production data to tailor the production of the further chemical product to the needs of the consumption location. For instance, different consumption locations may require the use of different production parameters to produce the further chemical product. The chemical production data may specify inbound material(s), optionally intermediate(s) and/or production processes. The chemical production data may specify the production chain(s) of the chemical production. The chemical production data may include a bill of materials for one or more production chain(s) of the chemical production. The chemical production data may include one or more recipe(s) specifying one or more inbound material(s) for production process(es) of the chemical production.

In one embodiment, the request to provide the decentral identifier includes data related to the chemical product data and/or an owner or product identifier associated with the chemical product data owner or the chemical product, respectively. In one embodiment the request to provide the decentral identifier includes data related to chemical product data and an owner identifier associated with the chemical product data owner or the chemical product. The owner/chemical product identifier may be a string identifier associated with a chemical product data owner name or the chemical product name. The owner or chemical product identifier may be provided by a physical identifier provider, such as a bar code or a tag like a RFID tag, or a QR code. Such communication may be completed via ad hoc WIFI, BLE beacon, and/or NFC. The communications between wallet apps may be performed via any available communication channel, including but not limited to, web servers, ad hoc WIFI, BLE beacon signal, NFC, a barcode or QR code scanning, etc.

The chemical product passport may be associated with the chemical product data owner by including the owner identifier during generation of the chemical product passport. The owner identifier may be used for data transaction, such as sharing or exchanging chemical product data. The owner identifier may be provided to a transaction manager. Providing the decentral identifier and the owner identifier of the data owner to a transaction manager or a decentral data consuming network node may simplify tracking of data transactions. Any transaction in the data ecosystem can e.g. be associated with the clear name of the data owner.

In an embodiment, generating the chemical product passport includes providing the decentral identifier associated with a physical entity of the chemical product. The decentral identifier may be provided to the node generating the chemical product passport. The decentral identifier may be generated by a node being different from the node generating the chemical product passport. The decentral identifier may be generated by the node generating the chemical product passport. The physical entity may relate to a physical chemical product that is associated with the decentral identifier. The decentral identifier may be associated with the physical entity of the chemical product the chemical product passport is generated for. The decentral identifier may be associated with the physical entity of the chemical product the chemical product data is associated with. The decentral identifier may be associated with the physical entity the chemical product will be supplied for and the chemical product passport is associated with. For instance, the decentral identifier may be associated with the physical entity of a component, a component assembly, an end product or the like produced from the chemical product. The decentral identifier may be associated with more than one physical entity the chemical product will be supplied for and the chemical product passport is associated with. For instance, the decentral identifier may be associated with the physical entity of a component, a component assembly and an end product produced using the chemical product at least in one production step. Associating the decentral identifier with different physical entity stages in the chemical supply chain allows for virtually tracking the supplied chemical product in the supply chain. This way the chemical product may be tracked e.g. up to the end of life of the end product.

In an embodiment, the data related to chemical product data includes one or more digital representation(s) pointing to the chemical product data or parts thereof. Hence, the chemical product passport may not contain the chemical product data or parts thereof, but one or more locators pointing to said chemical product data or parts thereof. The digital representation(s) may be regarded as access data to access the chemical product data or parts thereof. The data related to chemical product data may include multiple digital representations pointing to distinct parts of the chemical product data. The data related to chemical product data may include multiple digital representations pointing to different parts of the chemical product data. Such different parts may overlap in some data points. The digital representation(s) pointing to product data or parts thereof may comprise at least one interface to a decentral data providing network node associated with the chemical product passport, e.g. the decentral data network node providing access to the chemical product passport. The digital representation(s) may point directly or indirectly to the storage location of the chemical product data or parts thereof. The storage location may be a data base of or associated with or accessible by the data owner of the chemical product data. For enhanced security, the digital representation(s) may indirectly point to such storage location. The digital representation(s) may further include at least one interface to the decentral data network node. The digital representation(s) may include an endpoint for data exchange or sharing (resource endpoint) or an endpoint for service interaction (service endpoint), that is uniquely identified via a communication protocol. The digital representation(s) pointing to product data or parts thereof may hence be uniquely associated with the decentral identifier. The digital representation(s) may include an access point to the chemical product data or a link to access chemical product data. This way the chemical product data can be maintained and controlled by a data owner. Access can be provided via the representation of an access point simplifying data verification, integrity checks or quality checks and access control, since not multiple distributed data points need to be checked and access controlled. the chemical product passport may be regarded as a digital access element to access the chemical product data or parts thereof associated via the decentral identifier with the chemical product passport under control of the data owner of the chemical product data.

In an embodiment, the data related to the chemical product data includes chemical product data or parts thereof. Hence, the chemical product passport may contain the chemical product passport or parts thereof and may be regarded as a digital twin of the chemical product.

In an embodiment, the chemical product data includes a measured at least one physical and/or chemical property of the further chemical product, at least one physical and/or chemical property determined from collected data associated with the production of the further chemical product and/or data associated with the production of the further chemical product. The chemical property may be a property of the further chemical product that becomes evident during, or after, a chemical reaction. Hence, the chemical property may be any quality that can be established only by changing the chemical identity of the further chemical product. Examples of chemical properties include heat of combustion, enthalpy of formation, toxicity, chemical stability in a given environment, flammability, oxidation state(s), ability to corrode, combustibility, acidity and basicity, chemical product composition, recyclate content used for producing or manufacturing the chemical product, bio-based content used for producing or manufacturing the chemical product, renewable content used for producing or manufacturing the chemical product and pH value. Physical property may be any property that is measurable. Hence, the value of a physical property describes a state of the further chemical product. Examples of physical properties include absorption, brittleness, boiling point, capacitance, color, concentration, density, ductility, distribution, efficacy, elasticity, electric charge, electrical conductivity, electrical impedance, electric potential, flow rate, fluidity, hardness, heat capacity, inductance, intrinsic impedance, luminance, luminescence, luster, mass, melting point, opacity, permeability, permittivity, plasticity, pressure, radiance, resistivity, reflectivity, refractive index, solubility, specific heat, strength, stiffness, temperature.

The measured at least one physical and/or chemical property may be obtained by sensors configured to measure the physical and/or chemical property. The sensor may be included in a measuring device. The sensor may correspond to the measuring device. For example, the physical and/or chemical property may include a property provided by sensors of a mobile device such as a camera, or measurement devices configured to measure at least one physical and/or chemical property.

Data associated with the production of the further chemical product may be collected before, during and/or after production of the further chemical product. The collected chemical product data may be used to determine at least one physical and/or chemical property of the produced further chemical product. For instance, emission data, recycled content data and/or bio-based content data of the further chemical product may be determined based on data collected during production of the further chemical product. Data associated with the production of the further chemical product may include chemical production data from the production of the further chemical product. Data associated with the production of the further chemical product may include monitoring and/or control data associated with the production of the further chemical product.

Emission data may comprise any data related to environmental footprint of the further chemical product. Emission data may include data relating to greenhouse gas emissions e.g. released in production of the chemical product. Emission data may include data related to greenhouse gas emissions of operations of the chemical production producing the further chemical product (production, power plants and waste incineration). Scope 2 may comprise emissions from energy production which is sourced externally. Scope 3 may comprise all other emissions along the value chain. Specifically, this may include the greenhouse gas emissions of raw materials obtained from suppliers. Emission data may include data relating to the carbon footprint of the chemical product or a Product Carbon Footprint (PCF). Product Carbon Footprint (PCF) may sum up greenhouse gas emissions and removals from the consecutive and interlinked process steps related to the further chemical product. Cradle-to-gate PCF may sum up greenhouse gas emissions based on selected process steps: e.g. from the extraction of resources up to the factory gate where the further chemical product leaves the chemical production.

In an embodiment, the chemical product data relates to or includes different classes of chemical product data. A class may be regarded as a chemical product data set. For instance, the data related to the chemical product data may include one or more digital representation(s) pointing to different classes of the chemical product data. Hence, the chemical product passport may include one or more digital representation(s) pointing to different classes of the chemical product data. In another instance, the data related to the chemical product data may include one or more classes of chemical product data. Hence, the chemical product passport may include one or more classes of chemical product data.

The different classes may include physical data associated with the chemical product, chemical product declaration data, chemical product safety data, certificate of analysis data associated with the physical entity of the chemical product, chemical product emission data, recyclate content data associated with the physical entity of the chemical product, bio-based content data associated with the physical entity of the chemical product, chemical product production data, and combinations thereof.

One or more classes may be associated with at least one authorization mechanism or scheme. The authorization mechanism or scheme may include a rule that specifies which decentral data consuming network node get access under which conditions. For instance, emission data, recyclate content data, bio-based content data, data associated with the production of the further chemical product, or combinations thereof may be associated with at least one authorization mechanism or scheme restricting access to said data to defined decentral data consuming network nodes or to defined access conditions.

In an embodiment, the chemical product passport relates to or includes one or more authentication mechanisms or schemes associated with the decentral identifier and the data related to the chemical product data. Through the authentication mechanism data access by a decentral data consuming network node can be controlled in a secure manner and integrity of the decentral data providing network node can be ensured. This allows for more reliable, controlled and secure data exchange or sharing. The one or more authentication mechanisms associated with the decentral identifier may be provided to a node generating the chemical product passport and to at least one decentral authentication data registry, preferably accessible by the decentral data providing network node and/or the decentral data consuming network node. The authentication data registry may be a central registry such as a central file system, a centrally managed distributed database, and/or a centrally managed peer-to-peer network. The central configuration allows for higher control and standardization via a central node. The authentication data registry may be a decentral registry such as a distributed ledger, a decentralized file system, a distributed database, and/or a decentral peer-to-peer network. The decentral configuration allows for more efficient use of computing resources and strengthens control by the data owner.

In an embodiment, the chemical product passport relates to or includes one or more authorization mechanisms or schemes associated with the decentral identifier and the data related to the chemical product data. The authorization mechanisms may include authorization rule(s) including data transaction instructions or data transaction protocols, such as data usage policies, smart data contracts or more complex data processing instructions associated with decentral data providing and/or decentral data consuming network nodes. Through the authorization mechanism access and data usage of the chemical product data or parts thereof by a decentral data consuming network node can be controlled in a secure manner. The one or more authorization mechanisms may be provided to a node for generating the chemical product passport or for accessing the chemical product data or parts thereof.

In an embodiment, the chemical product passport is generated by a decentral participant network node of a decentral network. The decentral participant node may be in communication with a decentral data providing network node providing access to the digital twin. The decentral participant node may be associated with a decentral data providing network node providing access to the chemical product data and/or the data related to the chemical product data. The decentral network may be a decentral peer-to-peer communication network. The decentral network may include participant network nodes associated with participants of the chemical supply chain and may be configured to perform data transactions. The decentral participant node may comprise a network node of the decentral network. The network nodes associated with participants of the chemical supply chain may be associated with raw chemical product supplier, intermediate chemical products manufacturer, intermediate part manufacturer, component manufacturer, component assembly manufacturer or end product manufacturer. The data transactions may be based on a transaction protocol including authentication and/or authorization mechanism(s). Based on the authentication and/or authorization mechanism(s) a peer-to-peer communication between decentral network nodes associated with participants of the chemical supply chain may be established. The one or more authentication mechanism(s) may be associated with or linked to the decentral identifier included in the digital twin and/or the digital access element. The one or more authentication mechanism(s) associated with the decentral identifier included in the digital twin and/or the digital access element may be accessible by the decentral data providing network node and/or the decentral data consuming network node. The decentral configuration allows for more efficient use of computing resources and strengthens control by the data owners of the decentral network.

In an embodiment, the decentral data providing network node and the one or more decentral data consuming network node(s) may be part of the decentral network. The decentral data consuming network node and the decentral data providing network node may be regarded as decentral participant node(s) of the decentral network.

In an embodiment, the physical identifier is physically attached to the chemical product. In another embodiment, the physical identifier is physically attached to a packaging unit containing a quantity of the chemical product. The physical identifier may have one-to-one correspondence to a virtual identity or to a physical identity by means of a physical connection to the physical entity of the chemical product.

In an embodiment, assigning the physical identifier associated with the chemical product to the decentral identifier included in the chemical product passport includes encoding the decentral identifier in the physical identifier. For instance, the decentral identifier may be encoded in a bar code, or a QR code physically connected to the chemical product. In another instance, the decentral identifier may be stored on an RFID tag physically connected to the chemical product.

In another embodiment, assigning the physical identifier associated with the chemical product to the decentral identifier may include interrelating the physical identifier with the decentral identifier. For instance, the marker may be interrelated with the decentral identifier.

In an embodiment, the method further includes a step of providing a defined quantity of the produced further chemical product to the consumption location. The defined quantity may be present within packaging units. The defined quantity may be determined based a predefined maximum threshold associated with said consumption location. The predefined maximum threshold may be associated with the maximum amount of chemical product that should be stored at the consumption location. The defined quantity may then be determined from data related to the remaining quantity and said maximum threshold. The defined quantity may be determined based on data related to the available storage space and the remaining quantity. This ensures that enough further chemical product is provided while avoiding provision of a larger quantity of further chemical product than storage space is available for at the consumption location.

In an embodiment, the method further includes a step of providing the chemical product data associated with the produced further chemical product and/or the generated chemical product passport for access by a decentral data consuming network node, wherein access to the chemical product data or a part thereof is being controlled by a decentral data providing network node associated with the data owner of the chemical product data. The decentral data providing network node may comprise computer-executable instructions for providing and/or processing data, such as chemical product data set(s), by a data consuming network node. The decentral data providing network node may be associated with the chemical production producing the chemical product. The decentral data providing network node may be associated with the data owner of the chemical product data or parts thereof. The decentral data providing network node may be connected to one or more dedicated data storage(s) storing the chemical product data or parts thereof. The dedicated data storage(s) may be under control of the data owner of the chemical product data or parts thereof. The data owner may have access to the dedicated data storage(s). Access to the chemical product data or parts thereof may hence be under control of the data owner associated with the decentral data providing network node. This allows to retain full control over the chemical product data or the parts thereof by the data owner but at the same time enabling sharing of the chemical product data or parts thereof within the decentral network under controlled conditions, for example by using appropriate authorization and authentication mechanisms or schemes.

The decentral data consuming network node may comprise computer-executable instructions for accessing and/or processing data within the decentral network, such as chemical product data or parts thereof, provided by a decentral data providing network node. The decentral data consuming network node may be controlled or owned by or associated with a consumer of the chemical product and further chemical product. The consumer may be any entity processing the chemical product and further chemical product at a consumption location. The consumer may be any entity operating a production configured to process the chemical product and further chemical product at a consumption location. Processing may include using the chemical product to produce different chemical products, component, assemblies or end products. The consumer may be a downstream participant of the chemical value chain the produced chemical product and further chemical product is associated with, e.g. the chemical product and further chemical product is used in. For instance, the consumer may be a discrete product processor, such as a discrete product producer or a participant of the recycling process of the discrete product. Discrete products may be finished products that are distinct items capable of being easily identifiable, for example by counting. Examples of discrete products include automobiles, airplanes, shoes, etc. A discrete product may be broken down at the end of its lifecycle so that its components can be recycled. The consumer may receive the chemical product from the entity producing the chemical product, such as a chemical product producer. Via the decentral data consuming network node, the consumer of the chemical product and further chemical product may access the chemical product data or a part thereof associated with the supplied chemical product and further chemical product, thus allowing to improve production or recycling by using the accessed data. For instance, the accessed data may be used to enhance the properties of the resulting different chemical product, component or discrete product or the overall production efficiency. In another instance, the accessed data associated with the supplied chemical product and further chemical product and may be used control the production involving the supplied chemical product and further chemical product. In yet another instance, the accessed data may be used to reliably determine the chemical composition of the components to be recycled, thus improving recycling efficiency by determining the correct recycling process, recycling parameters, recycling plant, etc.

### BRIEF DESCRIPTION OF THE SEVERAL VIEWS OF THE DRAWINGS

These and other features of the present invention are more fully set forth in the following description of exemplary embodiments of the invention. To easily identify the discussion of any particular element or act, the most significant digit or digits in a reference number refer to the figure number in which that element is first introduced. The same reference numbers in the drawings and this disclosure are intended to refer to the same or like elements, components, and/or parts. The description is presented with reference to the accompanying drawings in which:

FIG. 1A. to FIG. 1C illustrate example embodiments of a centralized computing environment (FIG. 1A), a decentralized computing environment (FIG. 1B) and a distributed computing environment (FIG. 1C),

FIG. 2A illustrates an example of a chemical production controlled by an operating system to produce a chemical product associated with a chemical product passport,

FIG. 2B illustrates another example of a chemical production controlled by an operating system to produce a chemical product associated with a chemical product passport,

FIG. 3 illustrates an example of a production system producing a chemical product associated with one or more chemical product passport(s),

FIG. 4 illustrates an example system for controlling the production of a chemical product by a chemical production,

FIG. 5A, FIG. 5B illustrate a part of a chemical production producing coating materials from different raw materials,

FIG. 6A illustrates an example of monitoring the quantity of a chemical product at a consumption location via at least one sensor device,

FIG. 6B illustrates an example of a system for monitoring the quantity of a chemical product via at least one sensor device,

FIG. 6C illustrates an example of a system for remotely monitoring the quantity of a chemical product and managing reusable packaging units for the chemical product,

FIG. 7 illustrates an example of DID owner data, DID document data and decentral identity infrastructure,

FIG. 8 illustrates an example of relationships between passports and associated relationship representations specifying relationships between a chemical product and materials used to produce the chemical product,

FIG. 9 shows a schematic illustration of providing access via a decentral data providing network node associated with a data owner to chemical product data associated with a further chemical product using a decentral data consuming network node associated with data user,

FIG. 10 illustrates a flow chart of a method for controlling the production of a chemical product by a chemical production in accordance with an example embodiment of the present disclosure,

FIG. 11A illustrates a flow chart of an aspect of block 1004 of FIG. 10 in accordance with an example embodiment of the present disclosure,

FIG. 11B illustrates a flow chart of an aspect of block 1004 of FIG. 10 in accordance with an example embodiment of the present disclosure,

FIG. 12 illustrates a flow chart of an aspect of block 1012 of FIG. 10 in accordance with an example embodiment of the present disclosure,

FIG. 13 illustrates an example system and associated methods for generating a chemical product passport associated with a chemical product produced by a chemical production and providing access to the chemical product passport and chemical product data associated therewith.

### DETAILED DESCRIPTION

The detailed description set forth below is intended as a description of various aspects of the subject-matter and is not intended to represent the only configurations in which the subject-matter may be practiced. The appended drawings are incorporated herein and constitute a part of the detailed description. The detailed description includes specific details for the purpose of providing a thorough understanding of the subject-matter. However, it will be apparent to those skilled in the art that the subject-matter may be practiced without these specific details.

In one case, the illustrated separation of various parts in the figures into distinct units may reflect the use of corresponding distinct physical and tangible parts in an actual implementation. Alternatively, or in addition, any single part illustrated in the figures may be implemented by plural actual physical parts. Alternatively, or in addition, the depiction of any two or more separate parts in the figures may reflect different functions performed by a single actual physical part.

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks).

The following explanation may identify one or more features as “optional.” This type of statement is not to be interpreted as an exhaustive indication of features that may be considered optional; that is, other features can be considered as optional, although not explicitly identified in the text. Further, any description of a single entity is not intended to preclude the use of plural such entities; similarly, a description of plural entities is not intended to preclude the use of a single entity. Further, while the description may explain certain features as alternative ways of carrying out identified functions or implementing identified mechanisms, the features can also be combined together in any combination. Finally, the terms “exemplary” or “illustrative” refer to one implementation among potentially many implementations.

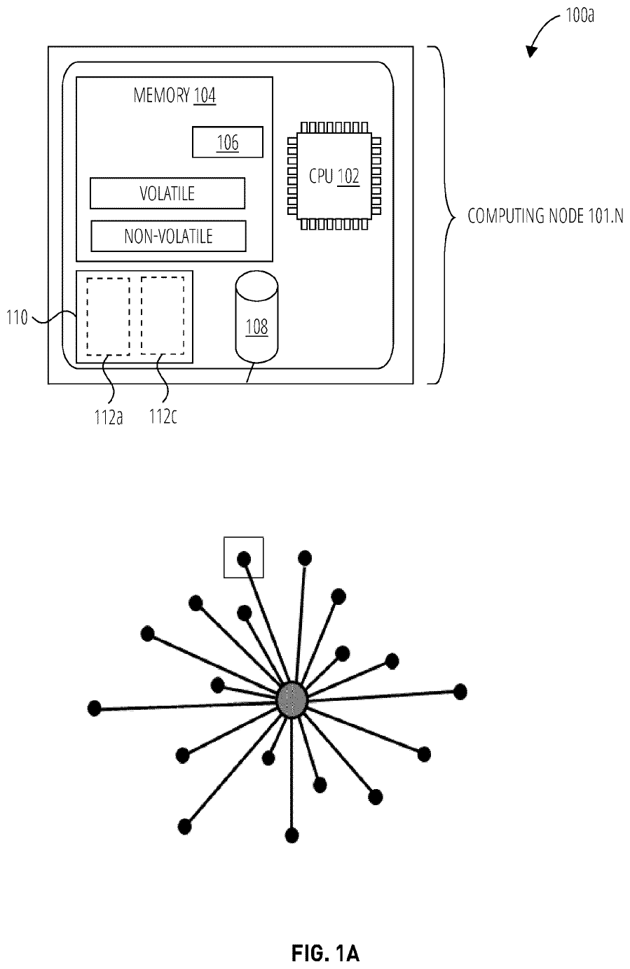

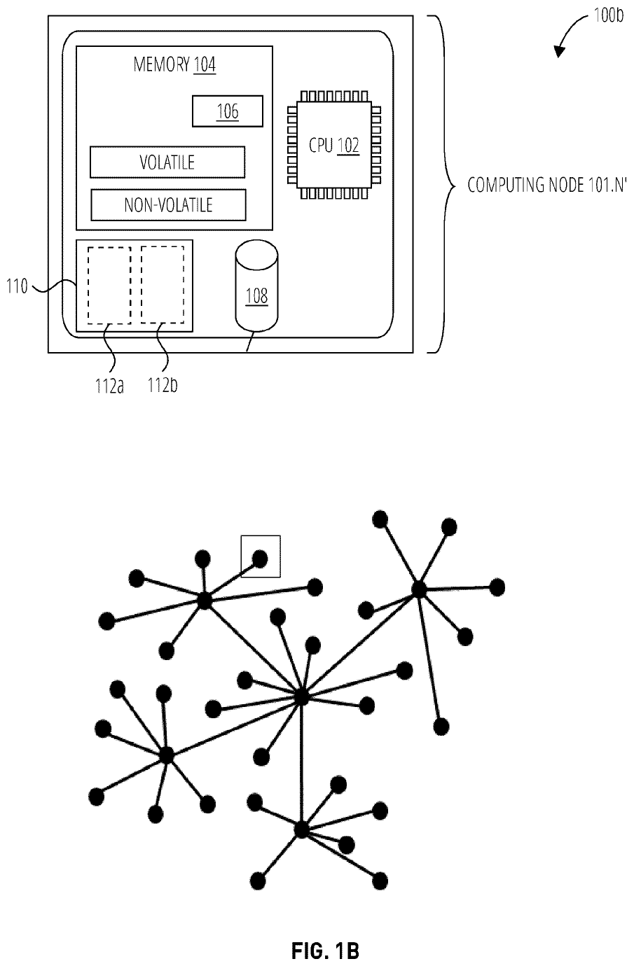

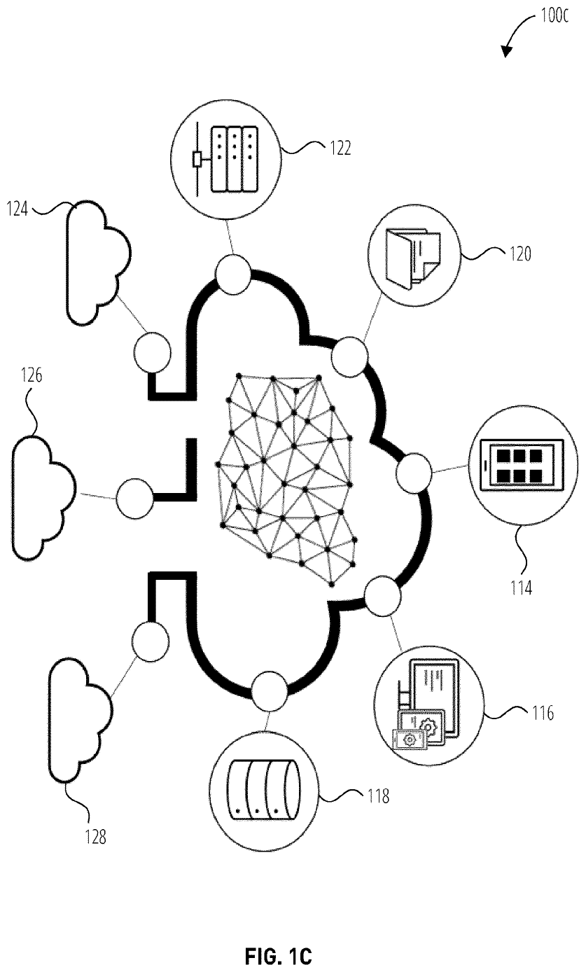

FIGS. 1A to 1C illustrate different computing environments, central, decentral and distributed. The methods, apparatuses, systems, and computer elements of this disclosure may be implemented in decentral or at least partially decentral computing environments. Providing, determining or processing of data may be realized by different computing nodes, which may be implemented in a centralized, a decentralized or a distributed computing environment.

FIGS. 1A, 1B illustrate example embodiments of a centralized and a decentralized computing environment with computing nodes. FIG. 1C illustrates an example embodiment of a distributed computing environment.

In this example of the centralized computing environment 100a, the peripheral computing nodes 101.1 to 101.N are connected to one central computing system (or server). In another example, the peripheral computing nodes 101.1 to 101.N may be attached to the central computing node via e.g. a terminal server (not shown). The majority of functions may be carried out by, or obtained from the central computing node (also called remote centralized location). One peripheral computing node 101.N has been expanded to provide an overview of the components present in the peripheral computing node. The central computing node may comprise the same components as described in relation to the peripheral computing node 101.N. Each computing node 101, 101.1 to 101.N may include at least one hardware processor 102 and memory 104.

The computing nodes 101, 101.1 . . . 101.N may include program code which is schematically represented as a plurality of structures 106. The multiple structures 106 may be referred to as an executable component, executable instructions, computer-executable instructions or instructions. Executable component or any equivalent thereof may be the name for a structure that is well understood to one of ordinary skill in the art in the field of computing as being a structure that can be software, hardware, or a combination thereof or which can be implemented in software, hardware, or a combination. For instance, when implemented in software, one of ordinary skill in the art would understand that the structure of an executable component includes software objects, routines, methods, and so forth, that is executed on the computing nodes 101, 101.1 . . . 101.N, whether such an executable component exists in the heap of a computing node 101, 101.1 . . . 101.N, or whether the executable component exists on computer-readable storage media. In such a case, one of ordinary skill in the art will recognize that the structure of the executable component exists on a computer-readable medium such that, when interpreted by one or more processors of a computing node 101, 101.1 . . . 101.N (e.g., by a processor thread), the computing node 101, 101.1 . . . 101.N is caused to perform a function. Such a structure may be computer-readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing. Examples of executable components implemented in hardware include hardcoded or hardwired logic gates, that are implemented exclusively or near-exclusively in hardware, such as within a field-programmable gate array (FPGA), an application-specific integrated circuit (ASIC), or any other specialized circuit. In this description, the words component, agent, manager, service, engine, module, virtual machine or the like are used synonymous with executable component.

The processor 102 of each computing node 101, 101.1 . . . 101.N may direct the operation of each computing node 101, 101.1 . . . 101.N in response to having executed computer-executable instructions that constitute an executable component. For example, such computer-executable instructions may be embodied on one or more computer-readable media that form a computer program product. The computer-executable instructions may be stored in the Memory 104 of each computing node 101, 101.1 . . . 101.N. Computer-executable instructions comprise, for example, instructions and data which, when executed at a processor 101, cause a general purpose computing node 101, 101.1 . . . 101.N, special purpose computing node 101, 101.1 . . . 101.n, or special purpose processing device to perform a certain function or group of functions. Alternatively, or in addition, the computer-executable instructions may configure the computing node 101, 101.1 . . . 101.N to perform a certain function or group of functions. The computer executable instructions may be, for example, binaries or even instructions that undergo some translation (such as compilation) before direct execution by the processors, such as intermediate format instructions such as assembly language, or even source code.

Each computing node 101, 101.1 . . . 101.N may contain communication channels 108 that allow each computing node 101.1 . . . 101.N to communicate with the central computing node 101, for example, a network enabling the transport of electronic data between computing nodes 101, 101.1 . . . 101.N and/or modules and/or other electronic devices. When information is transferred or provided over a network or another communications connection (either hardwired, wireless, or a combination of hardwired or wireless) to a computing node 101, 101.1 . . . 101.N, the computing node 101, 101.1 . . . 101.N properly views the connection as a transmission medium. Transmission media can include a network and/or data links which can be used to carry desired program code means in the form of computer-executable instructions or data structures and which can be accessed by a general-purpose or special-purpose computing nodes 101, 101.1 . . . 101.N. Combinations of the above may also be included within the scope of computer-readable media.

The computing node(s) 101, 101.1 to 101.N may further comprise a user interface system 110 for use in interfacing with a user. The user interface system 110 may include output mechanisms 112a as well as input mechanisms 112c. The principles described herein are not limited to the precise output mechanisms 112a or input mechanisms 112c as such will depend on the nature of the device. However, output mechanisms 112a might include, for instance, displays, speakers, displays, tactile output, holograms and so forth. Examples of input mechanisms 112c might include, for instance, microphones, touchscreens, holograms, cameras, keyboards, mouse or other pointer input, sensors of any type, and so forth.

FIG. 1B illustrates an example embodiment of a decentralized computing environment 100′ with several computing nodes 101.1′ to 101.N′ denoted as filled circles. In contrast to the centralized computing environment 100a illustrated in FIG. 1A, the computing nodes 101.1′ to 101.N′ of the decentralized computing environment 100b are not connected to a central computing node and are thus not under control of a central computing node. Instead, resources, both hardware and software, may be allocated to each individual computing node 101.1′ . . . 101.N′ (local or remote computing system) and data may be distributed among various computing nodes 101.1′ . . . 101.N′ to perform the tasks. Thus, in a decentral system environment, program modules may be located in both local and remote memory storage devices. One computing node 101.N′ has been expanded to provide an overview of the components present in the computing node 101.N′. In this example, the computing node 101.N′ comprises the same components as described in relation to computing node 101.N of FIG. 1A.

FIG. 1C illustrates an example embodiment of a distributed computing environment 100c. In this example, the distributed cloud computing environment 100c may contain the following computing resources: mobile device(s) 114, applications 116, databases 118, data storage 120 and server(s) 122. The cloud computing environment 100c may be deployed as public cloud 124, private cloud 126 or hybrid cloud 128. A private cloud 126 may be owned by an organization and only the members of the organization with proper access can use the private cloud 126, rendering the data in the private cloud at least confidential. In contrast, data stored in a public cloud 124 may be open to anyone over the internet. The hybrid cloud 128 may be a combination of both private and public clouds 126, 124 and may allow to keep some of the data confidential while other data may be publicly available.

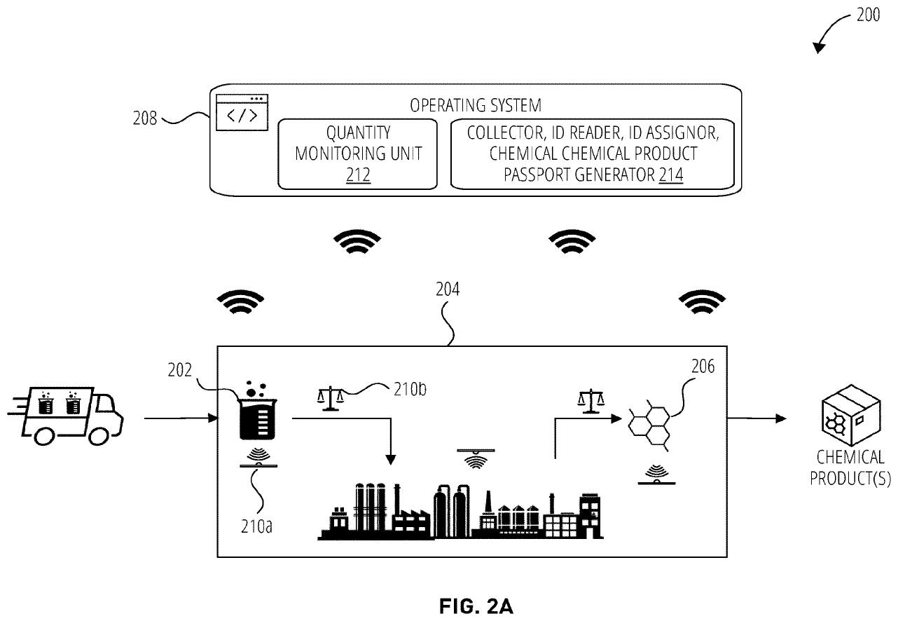

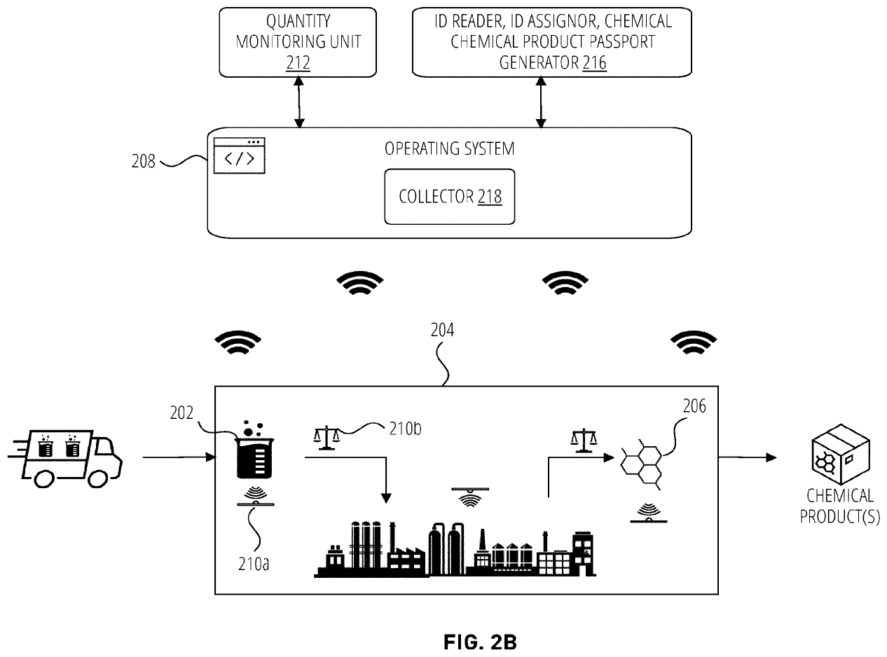

FIG. 2A illustrates an example of a chemical production 204 producing one or more chemical products(s) from one or more inbound material(s) 202 in connection with an operating system 208. For producing one or more chemical product(s) 206, different chemical materials 202 (also called inbound material 202 hereinafter) may be provided as physical inputs from material providers or suppliers. The physical inputs to the chemical production 204 may include chemical materials, such raw materials, intermediate materials or a combination thereof. Raw materials may be virgin or recycled raw materials. The inbound material 202 may be fed into the chemical production 204 at any entry point. The inbound material 202 may be fed into the chemical production 204 at the start of the chemical production 204. The inbound materials may be considered input for the chemical production 204.

The chemical production 204 may be a chemical production network including multiple interlinked processing steps. The chemical production network may be an integrated chemical production network with interrelated production chains. The chemical production network may include multiple different production chains that have at least one intermediate product in common. The chemical production network may include multiple stages of the chemical value chain. The chemical production network may include multiple production chains that produce from one or more inbound material(s) as input chemical products as output. The chemical production network may include multiple tiers of a chemical value chain. The chemical production network may include a physically interconnected arrangement of production sites. The production sites may be at the same location or at different locations. In the latter case, the production sites may be interconnected by means of dedicated transportation systems such as pipelines, supply chain vehicles, like trucks, supply chain ships or other cargo transportation means.

The chemical production 204 may include multiple production steps. The production steps included in the chemical production 204 may be defined by the system boundary of the chemical production 204. The system boundary may be defined by location or control over production processes. The system boundary may be defined by the site of the chemical production 204. The system boundary may be defined by production processes controlled by one entity or multiple entities jointly. The system boundary may be defined by value chain with staggered production processes to the chemical product, which may be controlled by multiple entities separately.

The chemical production 204 may convert inbound material 202 to one or more chemical products 206 that exit the chemical production 204. The conversion may be performed via intermediate chemical products. The conversion may be a chemical reaction or any other processing step, such as physical processing. The chemical reaction may result in a mixture of different chemical product(s) since the yield of the chemical reaction may be less than 100%. Hence, a chemical reaction of one or more starting materials, such as inbound material(s) 202, may result in a mixture of different chemical product(s). Chemical reactions may therefore be characterized by a one-to-many or many-to-many relationship between starting materials and resulting reaction productions. This is in contrast to discrete manufacturing, where a many-to-one relationship between parts/components and assemblies is existing, e.g. the result of a discrete manufacturing step is a concrete and predictable assembly. Since the yield of a chemical reaction is not 100%, the amount of desired chemical product 206 (e.g. chemical product(s) to be supplied to upstream participants of the chemical ecosystem) is less than the theoretical amount of said chemical product calculated from the amount of starting materials. Such mixtures typically require separation of the different chemical products contained in said mixture. This allows to avoid a negative influence of impurities and unreacted inbound material(s) 202 on the further processing of the chemical product 206. Separation may include distillation, washing, extraction, crystallization and recrystallization. The resulting mixture may contain unreacted starting material, such as unreacted inbound material 202. Unreacted starting material may be reintroduced into the chemical reaction to reduce the amount of required starting material. The resulting mixture may contain desired chemical product(s) 206 to be supplied to upstream participants of the chemical ecosystem, such as chemical product consumers or chemical product processors. The resulting mixture may contain intermediate chemical product(s) used as input material in further chemical reactions performed within the chemical production 204. This allows to reduce the amount of waste associated with the disposal of said intermediate chemical products and/or the amount of energy associated with transportation of these intermediate products to another chemical production. The resulting mixture may contain waste chemical product(s), e.g. chemical product(s) which cannot be used any further and which need to be disposed, for example by burning. Waste chemical products may be produced from undesired chemical side reactions.

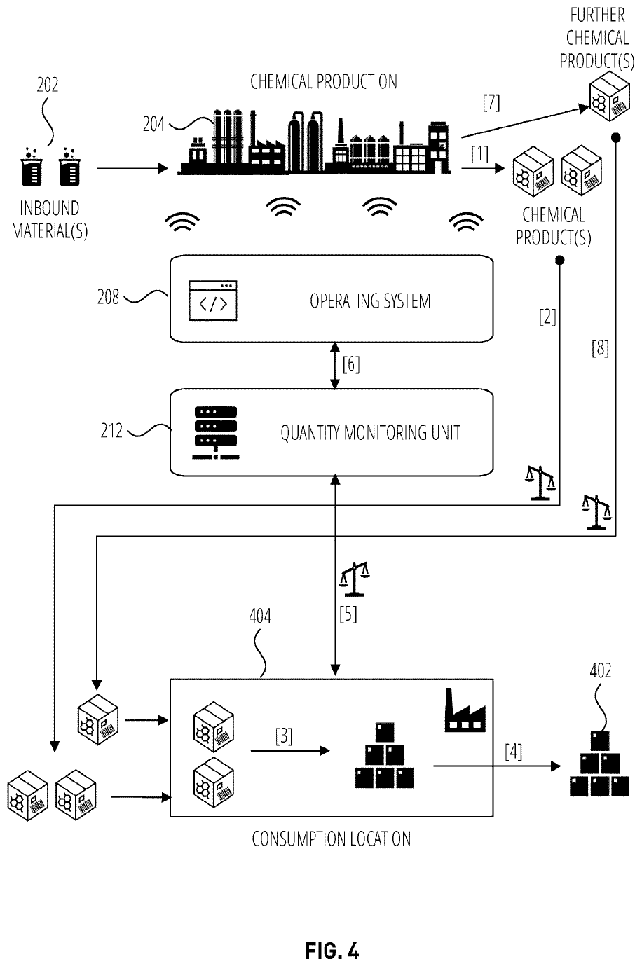

The chemical production 204 may comprise a plurality of sensors 210a, 210b. The sensors 210a, 210b may measure at least one chemical and/or physical property of the chemical product(s) 206 produced by the chemical production 204. The sensors 210a, 210b may measure at least one chemical and/or physical property of the inbound material(s) 202 provided to the chemical production 204. The sensors 210a, 210b may include sensors 2010b configured to determine the amount of inbound material(s) 202 and/or produced chemical product(s). Examples of such sensors may include scales or flow meters. The sensors 210a, 210b may include sensors 210a configured to measure at least one chemical and/or physical property of the inbound material(s) 202. Measurement of chemical and/or physical properties of the inbound material(s) 202 allows to control production processes based on the measured data. The sensors 210a, 210b may include sensors 210a configured to determine chemical and/or physical properties of the produced chemical product 206. Sensors 210a configured to measure chemical properties may measure data associated with or corresponding to the heat of combustion, enthalpy of formation, toxicity, chemical stability in a given environment, flammability, oxidation state(s), ability to corrode, combustibility, acidity and basicity and pH value. Sensors 210a configured to measure physical properties may measure data associated with or corresponding to absorption, brittleness, boiling point, capacitance, color, concentration, density, ductility, distribution, efficacy, elasticity, electric charge, electrical conductivity, electrical impedance, electric potential, flow rate, fluidity, hardness, heat capacity, inductance, intrinsic impedance, luminance, luminescence, luster, mass, melting point, opacity, permeability, permittivity, plasticity, pressure, radiance, resistivity, reflectivity, refractive index, solubility, specific heat, strength, stiffness, temperature, tension, thermal conductivity, thermal resistance, viscosity, volume and wave impedance. Data measured by sensors 210a, 210b may be stored in one or more databases, for example databases contained in data source layer 420 of FIG. 4B. The one or more databases may be distributed databases. The stored data may be interrelated with input material identifier(s) and/or chemical product identifier(s), respectively.

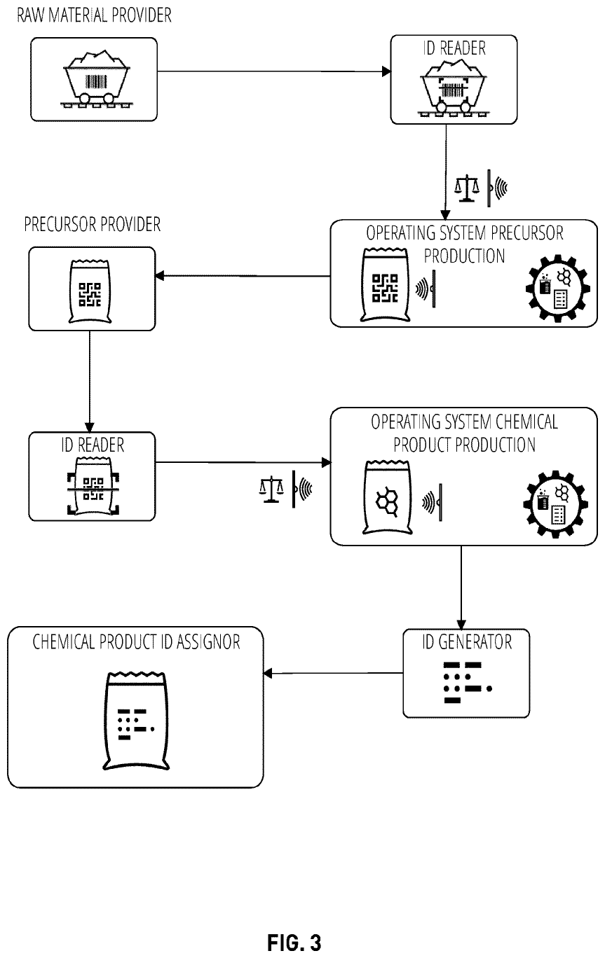

The physical inputs may be associated with a decentral identifier. Said decentral identifier may be associated with a material passport, which may be used to access material data associated with such decentral identifier, for example as described in relation to FIG. 3.

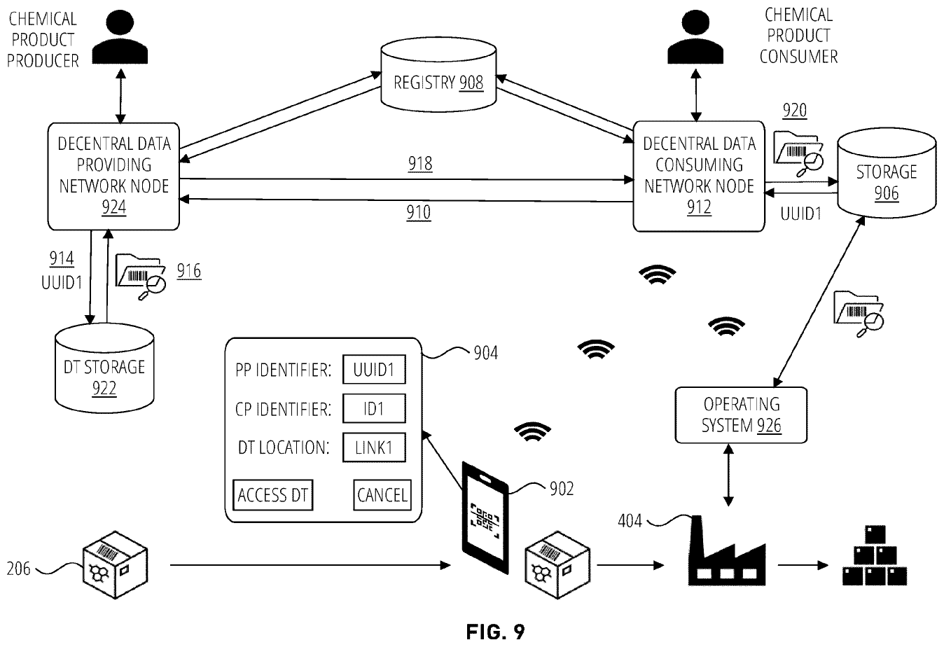

The chemical production 204 may produce the chemical product(s) 206 based on one or more physical input(s). The chemical product may be provided to a consumption location. Upon receiving a trigger from the quantity monitoring unit 212, the chemical production 204 may produce further chemical product. Upon or after production of the further chemical product, a chemical product passport may be generated for the produced further chemical product, for example as described in the context of FIG. 9. A chemical product passport may be generated for each batch of produced further chemical product. The chemical product data associated with the chemical product passport may be provided to a decentral network for access by other participants of the network, for example by the consumer of the further chemical product. This way the chain of input to output material may be made traceable and usable in further production steps without exposing the chemical product data in an uncontrolled manner.

The operating system 208 of the chemical production 204 may monitor and/or control the chemical production 204 based on operating parameters of the different processes. The operating system 208 may receive production demand data associated with the production planning for the chemical production 204. The production demand data may be produced based on quantities consumed at the consumption location. The production demand data may include target capacities for chemical products produced by the chemical production 204. The operating system 208 may further receive a bill of materials associated with the chemical product to be produced. The bill of materials may include material data associated with the materials used to produce the chemical product, process data associated with the production chain for producing the chemical product and/or chemical product data associated with the chemical product, such as product specification data or data on the amount of chemical product to be produced.

Based on the received production demand data and the bill of materials, material demand data may be determined. The material demand data may include data on the amount of material required to produce the target capacities of chemical product. The material demand data may include material identifiers associated with materials required to produce the chemical product and data on amounts of material for respective materials. The material demand data may include one or more material specifier(s) per material identifier signifying the material specification. The material demand data may include data on the material amount per material identifier signifying the amount of material to be supplied. The material demand data may specify the production chain(s) of the chemical production 204. The material demand data may include a bill of materials for one or more production chain(s) of the chemical production 204. The material demand data may include one or more recipe(s) specifying one or more material(s) for production process(es) of the chemical production 204.

One process step monitored and/or controlled by the operating system 208 may be the feed of materials 204 or the release of chemical products 206. Another process step monitored and/or controlled may be the separation of chemical product(s) contained in mixtures resulting from chemical reactions performed within the chemical production 204. Another process step monitored and/or controlled may be the determination of chemical and/or physical properties of produced chemical product(s) 206 from data collected associated with the production of the chemical product, such as data measured by sensors 210a, 210b before, during and/or after production of the chemical product(s) 206. The operating system 208 may be configured to access data related the materials 204, the processes and/or the chemical products 206 produced by the chemical production 202. The operating system 208 may be configured to monitor the quantity of chemical product present at the consumption location by gathering data being indicative of the quantity of the chemical product at the consumption location and comparing the gathered data to a predefined minimum threshold. The operating system 208 may be configured to trigger the production of further chemical product if the monitored quantity has reached or has fallen below the predefined minimum threshold. The operating system 208 may be configured to receive a request to provide a decentral identifier. The operating system 208 may be configured to provide a link to the chemical product data or to provide the chemical product data and to generate the chemical product passport. The operating system 208 may be configured to assign a physical identifier connected to the further chemical product(s) produced by the chemical production 204 to the decentral identifier contained in the chemical product passport.

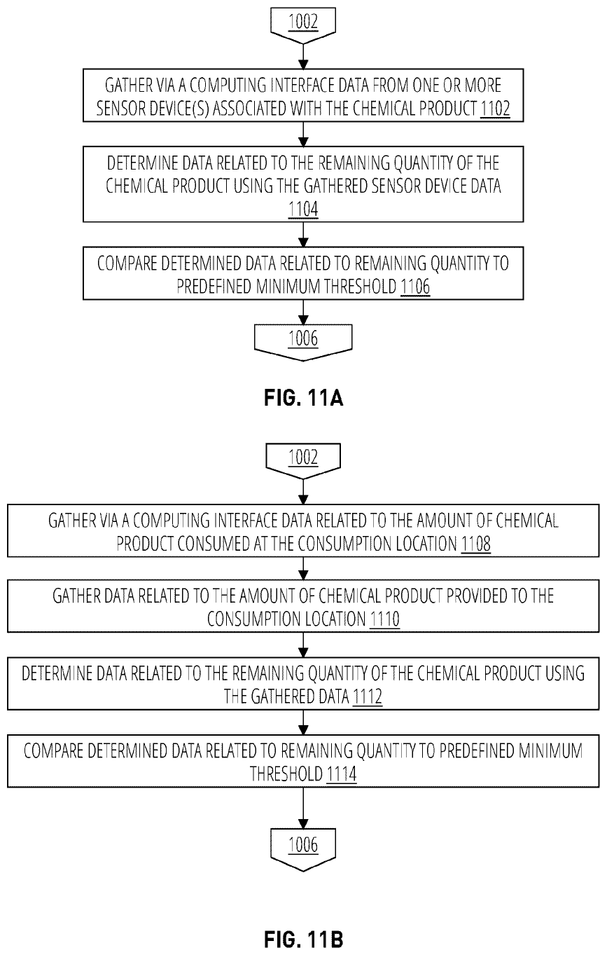

The operating system 208 may include a quantity monitoring unit 212 configured to monitor the quantity of chemical product present the consumption location. The quantity monitoring unit 210 may be configured to determine the remaining quantity of chemical product present at the consumption location and to compare the remaining quantity to a predefined minimum threshold, for example as described in relation to FIGS. 4, 6A, 10, 11A and 11B. The remaining quantity may be determined as described in the context of FIGS. 11A and 11B.

The operating system 208 may include a collector configured to collect chemical product data associated with the chemical product. The collector may be configured to collect the chemical product data any time before, during and/or after production of the chemical product. The collector may be configured to store the collected chemical product data within one or more databases. The chemical product data may be collected based on a chemical product identifier associated with the chemical product. The collected chemical product data may be interrelated with the chemical product identifier to allow gathering of said data based on the chemical product identifier.

The requestor may be configured to generate a request to generate the chemical product passport. The request may contain data related to the chemical product data and optionally an owner identifier. The request may be received at the chemical product passport generator and the chemical product passport generator may, in response to the request, provide the decentral identifier and generate the chemical product passport. The decentral identifier may comprise any unique identifier uniquely associated with the data owner and the identified chemical product. The decentral identifier may include at least one Universally Unique IDentifier (UUID) or at least one Digital IDentifier (DID). The decentral identifier may be issued by a central or decentral identity issuer. The decentral identifier may include authentication information for authentication of the data relating to the chemical product data. Via the decentral identifier and its unique association with the chemical product, access to the chemical product data may be controlled by the data owner of the chemical product data. This contrasts with central authority schemes, where identifiers are provided by central authority and access to such data is controlled by such central authority. Decentral in this context refers to the usage of the identifier as controlled by the data owner. The chemical product data may be hosted in a database associated with, accessible by or under control of the data owner. The decentral identifier may include one or more identifier(s) used in a decentral computing environment and allowing for data exchange via the decentral computing environment, such as the peer-to-peer communication channel. Data exchange may include discovery of the decentral identifier for participant nodes of the decentral computing environment, authentication of participant nodes of the decentral computing environment and/or authorization of data transfers via a peer-to-peer communication between participant nodes of the decentral computing environment.

The ID assignor may be configured to assign the decentral identifier included in the chemical product passport to a physical identifier of the produced chemical product as described in the context of FIG. 3. For instance, the ID assignor may generate a physical identifier having embedded the decentral identifier and may provide the physical identifier to a labeling device. In another example, the ID assignor may link the physical identifier with the decentral identifier. This way, the decentral identifier may be determined based on the physical identifier.

The quantity monitoring unit 212, the collector, the requestor, the ID assignor and the chemical product passport generator may be configured as decentral services or applications executed via the decentral network.

FIG. 2B illustrates another example of a chemical production 204 controlled by an operating system to produce a chemical product associated with a chemical product passport. The process steps described in the context of FIG. 2A may be executed via an operating system 208 of the chemical production 204 in communicative connection with the ID reader, the ID assignor, the chemical product passport generator 216 and the quantity monitoring unit. In this embodiment, the operating system 208 may be communicatively connected to the chemical production 204 and the ID reader, the ID assignor, and the chemical product passport generator 216 and the quantity monitoring unit 212. The operating system 208 may comprise a collector 218.

The quantity monitoring unit 212 may be configured to determine the quantity of chemical product present at the consumption location and to compare the determined current quantity to a predefined minimum threshold as described in relation to FIG. 2A. The collector 218 may be configured to collect data associated with the produced chemical product as described in the context of FIG. 2A. The ID reader may be configured to read the physical identifier physically connected to the inbound material and/or the produced chemical products as described in relation to FIG. 2A. The ID assignor may be configured to assign the decentral identifier and associated information to the physical identifier of the produced chemical products as described above in the context of FIG. 2A. The chemical product passport generator may be configured to provide the decentral identifier and associated information as well as to generate the chemical product passport including the decentral identifier and data related to the chemical product data as described in relation to FIG. 2A. The quantity monitoring unit 212, the ID assignor, the ID reader, the chemical product passport generator 216 and/or the collector 218 may be configured as decentral services or applications executed via the decentral network.

FIG. 2A and FIG. 2B only show two example embodiments and any combination of the system components shown in FIG. 2A and FIG. 2B may be possible. For instance, the ID reader may be configured as part of the operating system 208, while the collector and the ID assignor may not be configured as part of the operating system 208.

FIG. 3 illustrates an example of a production system producing chemical product(s) associated with chemical product passport(s) for different chemical products in the chemical ecosystem. FIG. 3 specifically illustrates an example for generating a chemical product passport for a precursor material (e.g. intermediate chemical product) and for generating a chemical product passport for a chemical product produced at least in part from said precursor material. The chemical product, such as chemical product 206, may be produced by a chemical production 204 comprising an operating system 208, for example as described in the context of FIG. 2A and FIG. 2B.

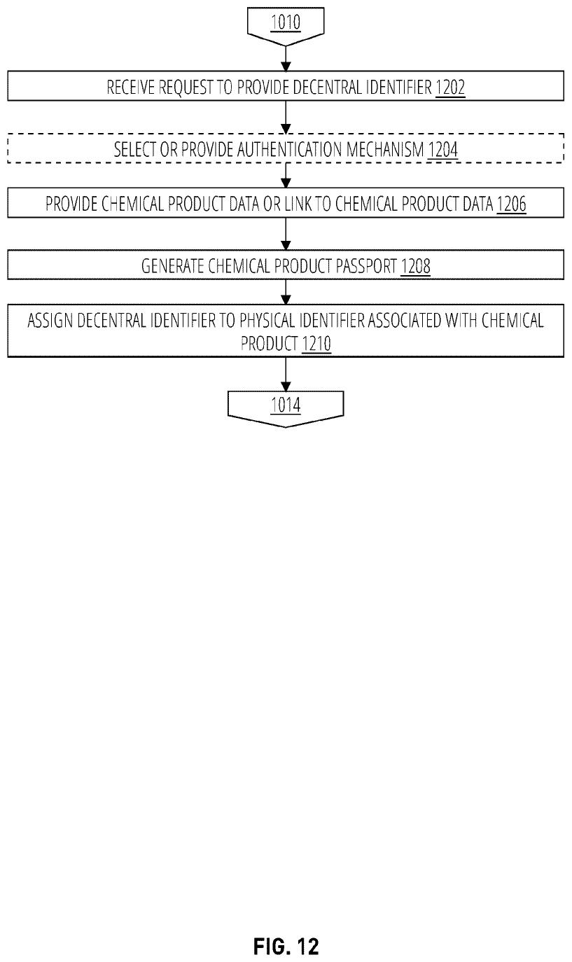

The production of a chemical product may comprise a two-step process: 1) production of intermediate chemical product(s) from one or more inbound material(s), and 2) production of the chemical product at least in part from the intermediate chemical product(s). To produce the intermediate chemical product(s), inbound materials may be used as physical inputs. The inbound materials may be provided from raw material provider(s). The inbound materials may include virgin or recycled materials. The inbound materials may be provided to an intermediate chemical product production as inbound material 202. The intermediate chemical product production may be a chemical production 204 as described in the context of FIG. 2A and FIG. 2B. The inbound materials may comprise a physical identifier. The physical identifier may be or may be associated with a decentral identifier (denoted as decentral inbound material identifier). The decentral inbound material identifier may be associated with a digital twin of the inbound materials. The decentral inbound material identifier may be associated with an inbound material passport. The operating system, such as the operating system 208 described in the context of FIG. 2A and FIG. 2B, of the intermediate chemical product production may comprise or be in communication with an ID reader configured to read the physical identifier and to determine the decentral inbound material identifier associated with said physical identifier. The decentral inbound material identifier may be associated with a chemical product passport of the respective inbound material. The chemical product passport of the inbound materials may be generated as described in the context of FIG. 12 below. The inbound material data included in or associated with the inbound material passport may include a measured physical and/or chemical property and/or a physical and/or chemical property determined from collected data associated with the production of the inbound material. The physical and/or chemical property may be measured with sensors as described in the context of FIG. 2A and FIG. 2B. The physical and/or chemical property may be determined from collected data as described in the context of FIG. 2A and FIG. 2B. The inbound material data may further include the inbound material name, inbound material producer, inbound material declaration data, inbound material safety data, emission data, recyclate content data, biobased content data, certificate of analysis data associated with the inbound material, certificates associated with the inbound material or a combination thereof.

The operating system may be configured to access the inbound material data or a part thereof of inbound material(s) provided to the intermediate chemical product production based on the determined decentral inbound material identifier(s) e.g. from decentral data providing network node(s) associated with the inbound material provider(s) (see for example FIG. 9). Such data may be used to operate the chemical production producing the intermediate chemical product(s). For instance, if the inbound material(s) are recycled material(s), production steps purifying the recycled material(s) may be performed. For instance, if the inbound material(s) are virgin materials, purification steps may be omitted. The intermediate chemical product(s) may be formed by chemically reacting the inbound material(s) and/or by physically processing the inbound material(s). Chemical reactions may include polymerization, precipitation and other chemical reactions commonly known. Physical processing may include mixing, grinding, extruding, etc. The intermediate chemical product production may include sensors, such as sensors 210a, 210b, measuring physical and/or chemical properties of the intermediate chemical product(s) produced by the intermediate chemical product production as described in the context of FIG. 2A and FIG. 2B. The operating system may be configured to determine physical and/or chemical properties from collected data associated with the production of the intermediate chemical product(s), for example as described in the context of FIG. 2A and FIG. 2B.

The operating system may be configured to generate intermediate product passport(s) for the produced intermediate chemical product(s) as described in the context of FIG. 12 below. Each intermediate product may include a decentral intermediate chemical product identifier and data related to the intermediate chemical product. The data related to the intermediate chemical product may include or point to intermediate chemical product data. The intermediate chemical product data may include at least one physical and/or chemical property of the respective intermediate chemical product. The physical and/or chemical property may be measured by sensors 210a, 210b and/or determined from collected data as previously described. The intermediate chemical product passport may further include or be associated with decentral inbound material identifier(s) of inbound material(s) used to produce the respective intermediate chemical product. This allows to track the inbound materials used to produce the respective intermediate chemical product. The intermediate chemical product passport may further include data previously described in relation with the inbound material passport of the inbound material(s). The produced intermediate chemical product(s) may be packaged, and the packaging may include a physical identifier, such as a QR code, an embossed code or an optical holographic code, such as zero-order diffractive microstructure. The physical identifier may be assigned to the respective decentral intermediate chemical product identifier of the intermediate chemical product passport. The assignment of the physical identifier and the decentral intermediate chemical product identifier may be executed through an ID assignor running locally, in a decentral system and/or in a distributed system (see also FIGS. 2A, 2B). For instance, the packaging line may comprise a labelling device detecting the packaging of the produced intermediate chemical product(s). Based on such recognition, a requestor may generate a request to provide the decentral intermediate chemical product identifier and the passport generator may generate the intermediate chemical product passport in response to the request. The decentral intermediate chemical product identifier included in the generated intermediate chemical product passport may be assigned, for example by the ID assignor, to the respective physical identifier. Assigning may include encoding the respective decentral intermediate chemical product identifier in a physical identifier and providing the physical identifier, such as a code, to the labelling device configured to attach the physical identifier to the respective intermediate chemical product, such as the packaging of the respective intermediate chemical product. The ID assignor may be part of the labelling device or may be a separate device.

In a second step, the intermediate chemical product(s) produced in step 1) may be provided to a chemical production as inbound material 202 to produce the chemical product 206. The chemical production may be the chemical production 204 described in the context of FIG. 2A and FIG. 2B. The chemical production may be the chemical production producing the intermediate chemical product(s). The chemical production may be different from the chemical production producing the intermediate chemical product(s). Apart from the intermediate chemical product(s) produced in step 1), further inbound material(s) may be provided to the chemical production and may be used to produce the chemical product 206. The intermediate chemical product(s) may comprise recycled intermediate chemical product(s) and/or intermediate chemical product(s) produced by a different intermediate chemical product production than the intermediate chemical product production described in the context of step 1). Such intermediate chemical product(s) may be associated with a physical identifier. The physical identifier may be associated with a decentral intermediate chemical product identifier via which the digital twin or a part thereof of the respective intermediate chemical product may be accessible. An ID reader may be used to read the physical identifier associated with the respective decentral intermediate chemical product identifier as described above. The intermediate chemical product data or a part thereof may be retrieved via a decentral data consuming network node associate with the chemical production using the decentral intermediate chemical product identifier as described above.

Production data from the intermediate chemical product production of the intermediate chemical product may be used by the operating system, such as operating system 208 described in the context of 2A and FIG. 2B, of the chemical production to produce the chemical product 206 as described above. The chemical production may include sensors, such as sensors 210a, 210b, measuring physical and/or chemical properties of the chemical product produced by the chemical production as described in the context of 2A and FIG. 2B. The operating system may be configured to determine physical and/or chemical properties from collected data associated with the production of the chemical product, for example as described in the context of 2A and FIG. 2B.

The operating system may be configured to generate a chemical product passport for the produced or packaged chemical product as described above. The chemical product passport may include a decentral identifier (decentral chemical product identifier) and chemical product data or a pointer to said chemical product data. The chemical product data may include at least one measured and/or determined physical and/or chemical property as outlined above. The chemical product passport may include or be associated with decentral intermediate chemical product identifier(s). This allows to track the intermediate chemical product(s) used to produce the chemical product and also indirectly the inbound material(s) used to produce the intermediate chemical product(s). The chemical product passport may include further data as outlined above, such as the producer name, producer brand, producer identifier, chemical product name, chemical product brand and chemical product identifier.

The produced chemical product may be provided to a consumption location. The consumption location may be associated with a production consuming the chemical product to produce different products, such as different chemical products or discrete products. The operating system associated with the consumption location may use the physical identifier to access chemical product data via the decentral chemical product identifier associated with said physical identifier, for example as illustrated in FIG. 9.

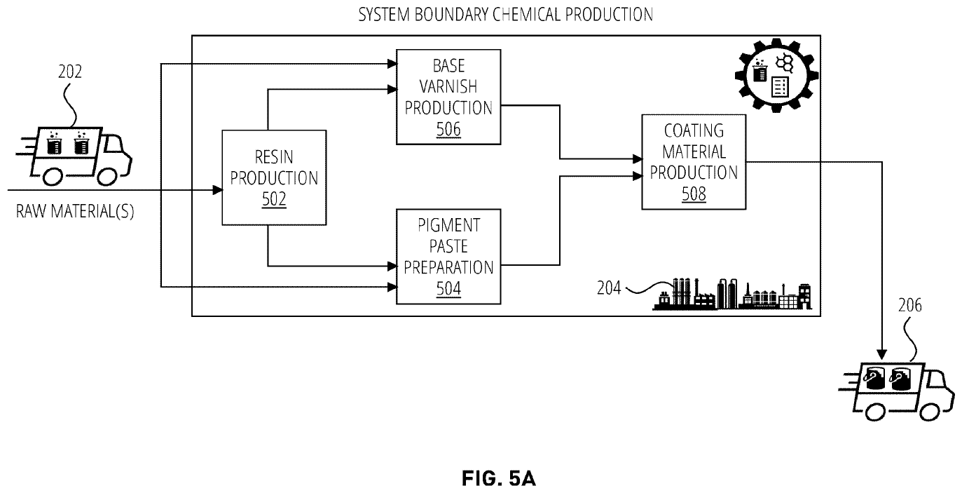

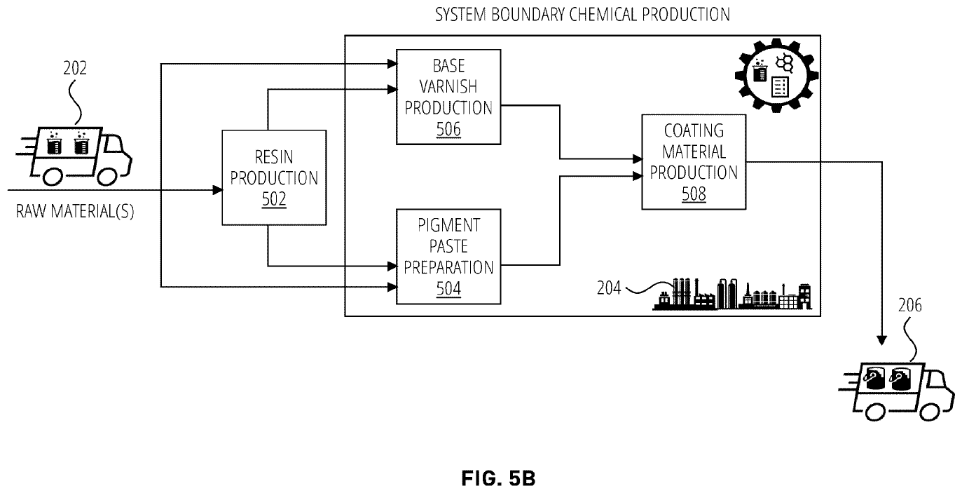

FIG. 4 illustrates an example system for controlling the production of a chemical product by a chemical production. The chemical production 204 may be a chemical production as described in the context of FIGS. 2A and 2B. The production may be controlled based on the quantity of chemical product consumed at a consumption location where the chemical product is supplied to. The chemical production may be a chemical production network as described in relation to FIG. 2A, FIG. 2B, FIG. 5A or FIG. 5B and may be associated with an operating system 208. The operating system 208 may be associated with a quantity monitoring unit 212. The operating system 208 may include the quantity monitoring unit 212 (not shown). The operating system 208 may include or be associated with an ID reader, an ID assignor and a chemical product passport generator as described in relation to FIG. 2A and FIG. 2B.

The inbound materials 202, such as monomers, pigments, solvents and/or additives, may be provided to the chemical production 204. The inbound materials may enter the system boundary of the chemical production at the entry point, such as a resin plant or a base varnish production or a pigment paste production (see FIG. 5A and FIG. 5B). The inbound materials may be associated with a decentral inbound material identifier as described in relation to FIG. 3. Inbound material data associated with said decentral inbound material identifier may be accessed and used to produce the chemical product(s) by the operating system as described in relation to FIG. 3. The inbound materials may be used in the chemical production to produce one or more chemical product(s) from the materials (see step [1] of FIG. 4).

The produced chemical product(s) may comprise a physical identifier, such as a bar code or a QR-Code, physically attached to the packaging unit containing the chemical product. Each packaging unit may contain a defined quantity of chemical product. A defined quantity of the produced chemical product may be transported to a consumption location 404 (see step [2] of FIG. 4). The defined quantity may comprise one or more packaging units containing the chemical product. Data related to the quantity of chemical product provided to the consumption location may be gathered by quantity monitoring unit 212 from operating system 208, for example as described in the context of FIG. 11B.

The consumption location 404 may be a further chemical production or a discrete production producing discrete products. Discrete products may be any products associated with a distinct physical unit. Discrete manufacturing in contrast to process manufacturing use such discrete products to assemble other discrete products. The consumption location may be associated with an operating system configured to monitor and/or control the production of products at the consumption location. The chemical products may enter the system boundary of the consumption location 404 at the entry point. The chemical product may be provided to a product storage or a plant (not shown) associated with the consumption location 404. The product storage may be a warehouse, a tank, etc. associated with the consumption location 404. The chemical products may be associated with a decentral identifier as described in relation to FIG. 3. Chemical product data associated with said decentral identifier may be accessed and used for the production within the consumption location 404 by the operating system associated with said consumption location (not shown) as described in relation to FIG. 3. The provided chemical products may be used in within the consumption location 404 to produce one or more product(s) 402 from the chemical product(s) (see step [3] of FIG. 4). The product 402 produced within the consumption location 404 may be provided to further participants of the chemical product ecosystem, such as end consumers (see step [4] of FIG. 4).

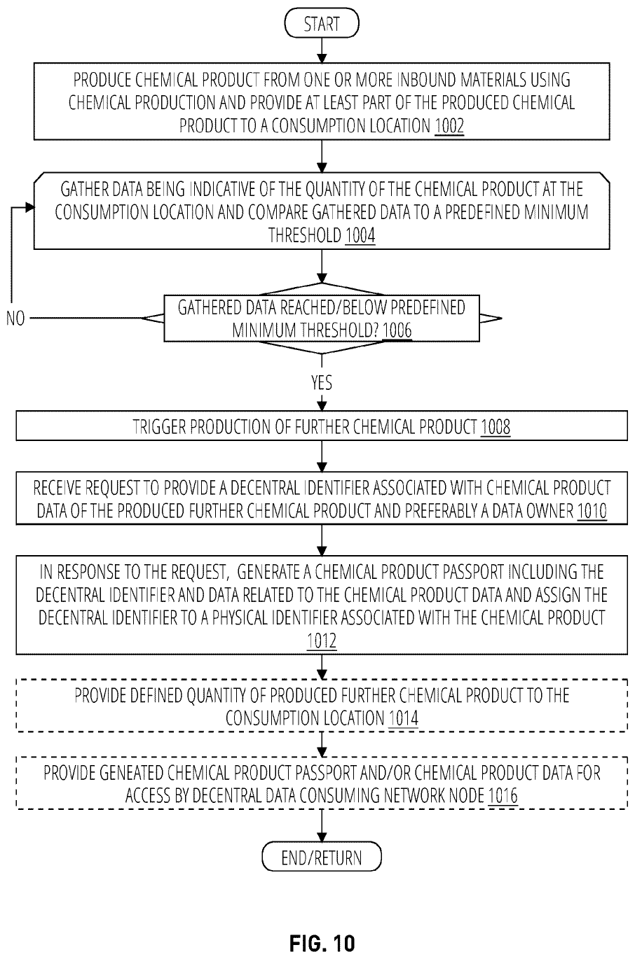

The quantity monitoring unit 212 may monitor the quantity of chemical product present at the consumption location 404, for example as described in the context of FIGS. 10, 11A and 11B (step [5] of FIG. 4). Chemical product present at the consumption location 404 may include chemical product provided to the consumption location 404. Said provided chemical product may be stored in a product storage or may be present within a tank connected with pipes to a production plant associated with the consumption location 404. Monitoring the quantity may include gathering data being related to the amount of chemical product consumed at the consumption location 404, for example as described in the context of FIG. 11B. The data may be gathered, for example, from the operating system associated with the consumption location 404 and determining data related to the remaining quantity of chemical product using said gathered data. For instance, the quantity monitoring unit 212 may gather production demand data used by the operating system of the consumption location 404 to control the production within the consumption location (see FIG. 2A). The production demand data may include data on the amount of chemical product signifying the amount of chemical product to be supplied. Quantity monitoring unit 212 may gather the production demand data based on the decentral chemical product identifier or a chemical product identifier associated with the provided chemical product. Quantity monitoring unit 212 may gather from operating system 208 associated with the chemical production 204 data related to the quantity of chemical product provided to the consumption location 404, for example by using the chemical product identifier. Quantity monitoring unit 212 may be configured to determine data being indicative of the quantity of the chemical product present at the consumption location 404 from the data related to the amount of the chemical product consumed at the consumption location, such as the production demand data, and the data related to the amount of chemical product provided to the consumption location.

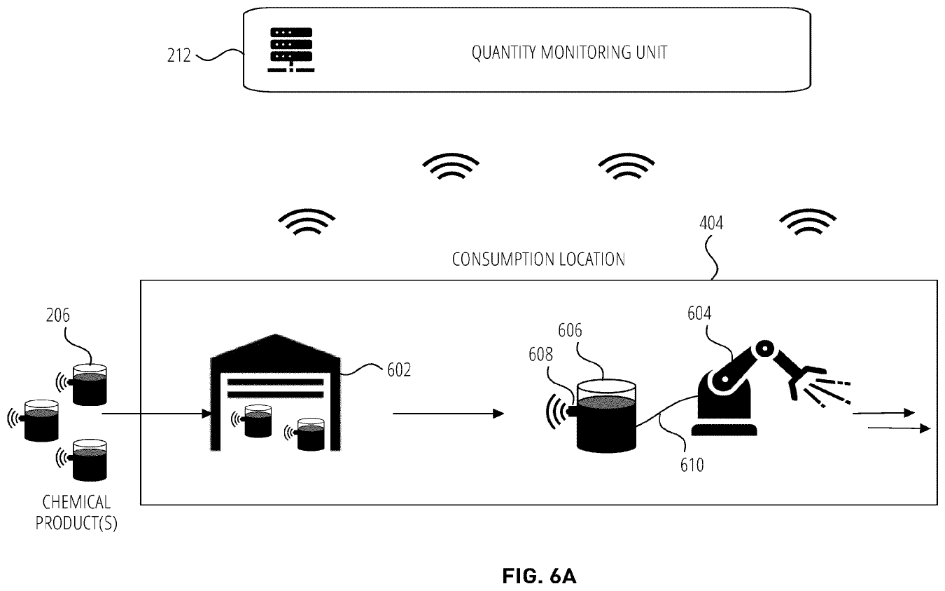

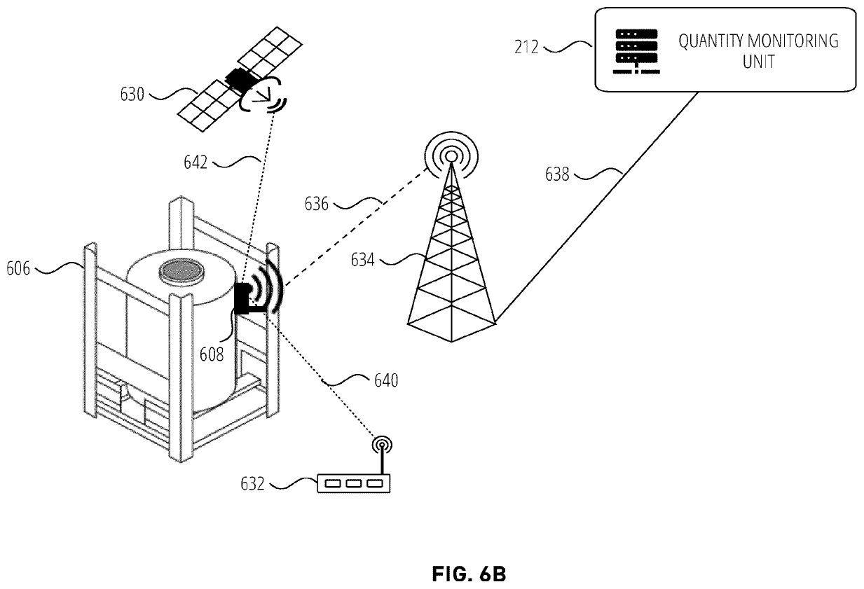

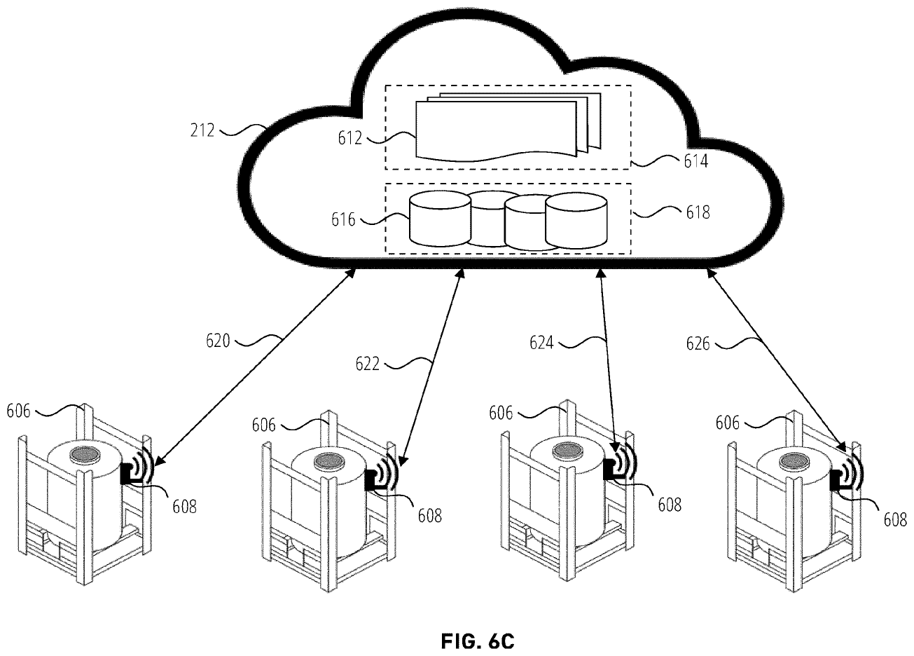

Monitoring the quantity may include gathering sensor data from at least one sensor device, such as sensor device 608, and using said gathered sensor data to determine the data being indicative of the quantity of chemical product present at the consumption location, for example as described in the context of FIG. 11A. The sensor device may be attached to the packaging unit of the provided chemical product(s), for example as described in relation to FIG. 6A, FIG. 6B and FIG. 6C. The sensor device may measure data being indicative of the amount of chemical product, for example by measuring data being indicative of the fill level of a liquid chemical product within the packaging unit, such as an intermediate bulk container. The sensor device may provide the acquired data via a communication interface to the quantity monitoring unit 212, for example as described in relation to FIG. 6B. The quantity monitoring unit 212 may receive the acquired data and may determine data related to the remaining quantity of the chemical product from said received data. The quantity monitoring unit 212 may be connected to one or more sensor device(s), each sensor device being attached to a packaging unit containing a defined amount of chemical product, for example as described in relation to FIG. 6C. The sensor data may contain the decentral chemical product identifier and/or a chemical product identifier associated with the chemical product. The sensor data may further contain a consumption location identifier. Use of said identifiers allows the quantity monitoring unit 212 to assign the determined data being indicative of the quantity the respective chemical product and consumption location. The data related to the remaining quantity may correspond to the sum of all the data being indicative of the quantity of the chemical product associated with the respective decentral chemical product identifier and/or chemical product identifier and optionally the consumption location identifier. This may allow the quantity monitoring unit 212 to monitor the amount of different chemical products supplied to different consumption locations using the gathered sensor data.

The quantity monitoring unit 212 may be configured to compare the determined data being indicative of the quantity of the chemical product to a predefined minimum threshold and to transmit the result of said determination to the operating system 208 (step [6] of FIG. 4). The quantity monitoring unit 212 may be configured to transmit the determined data being indicative of the quantity of the chemical product to the operating system 208 (step [6] of FIG. 4) and the operating system 208 may be configured to compare the received data to the predefined minimum threshold. If the data being indicative of the quantity of the chemical product has reached or has fallen below the predefined minimum threshold, the operating system 208 may trigger production of further chemical product, for example by generating production demand data and providing said production demand data to the respective plant of the chemical production 204. The plant may use the received production demand data to produce further chemical product from inbound material(s) 202 (see step [7] of FIG. 4). Triggering the production may include receiving data being indicative of an order for further chemical product from the operating system of the consumption location. The data may contain data associated with the chemical product, such as chemical product identifier, and data related to the required amount of chemical product. The data may be generated by the operating system associated with the consumption location in response to receiving an indication that the data being indicative of the quantity of the chemical product is below the predefined minimum threshold. The indication may be received from the quantity monitoring unit 212 or the operating system 208 of the chemical production 204. The production demand data may be generated by the operating system 208 after receiving the data being indicative of the order. The operating system 208 may use information contained in said data, for example the chemical product identifier and the required amount, to generate production demand data.

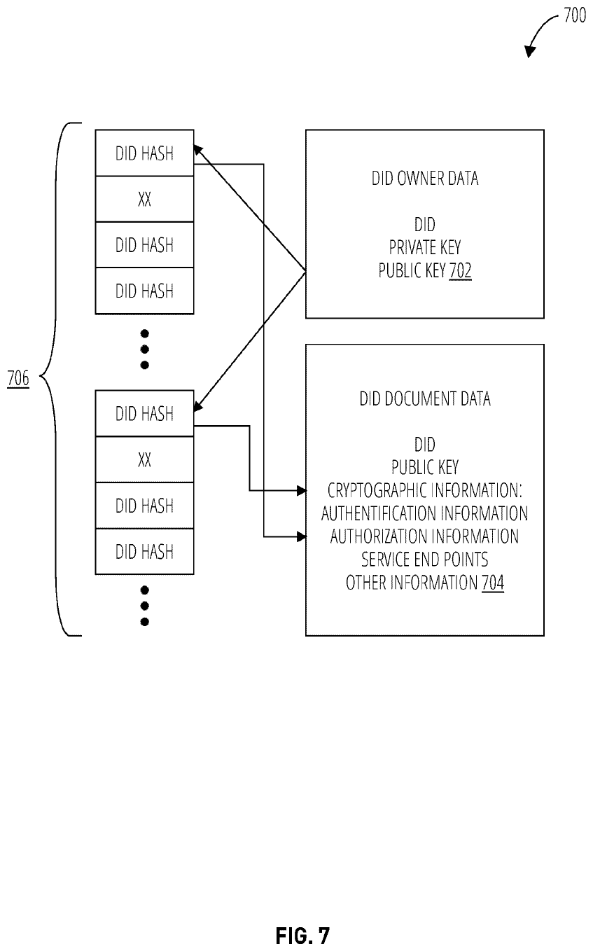

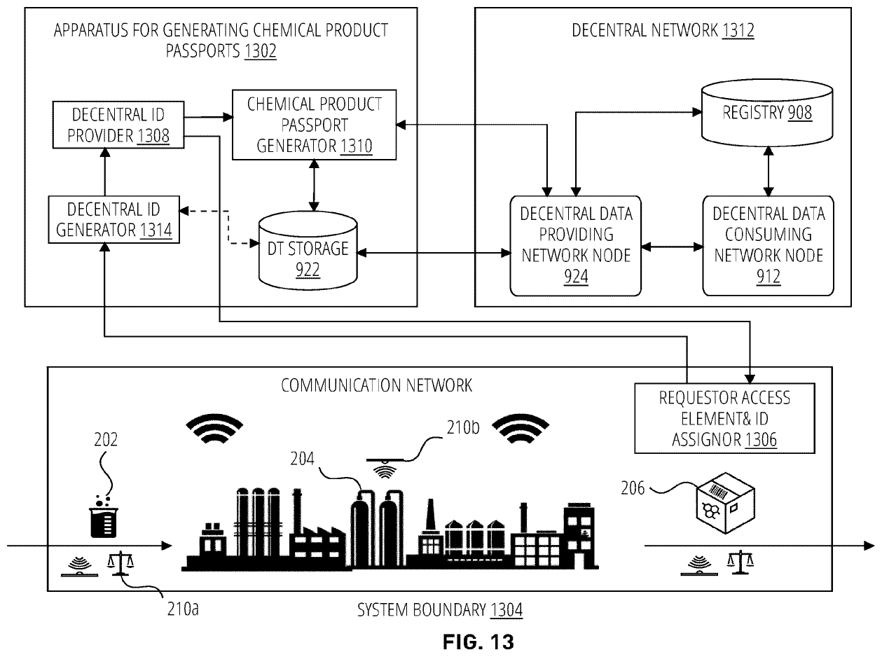

The produced further chemical product may comprise a physical identifier, such as a QR-Code, physically attached to the packaging unit. The physical identifier may be assigned to the decentral identifier. The assignment of physical identifier and decentral identifier may be executed through an ID assignor (see FIG. 2A, FIG, 2B) running locally, in a decentral system and/or in a distributed system. For instance, the packaging line may comprise a detector detecting each packaging unit. Based on such recognition, the operating system 208 of the chemical product production 204 may request to provide a decentral identifier and the provided decentral identifier may be assigned, for example by the ID assignor, to the physical identifier as described in the context of FIG. 3. In response to the request, the chemical product passport including the decentral identifier and data related to chemical product data associated with the further chemical product may be generated, for example by the chemical product passport generator. For such generation, data related to the further chemical product as recorded prior and/or during production of the further chemical product may be gathered or accessed, for example as described in relation to FIG. 3. The chemical product passport may be generated upon or after production of the further chemical product, for example as described in the context of FIG. 12 and FIG. 13. An example chemical product passport is illustrated in FIG. 7.

The produced further chemical product may be provided to the consumption location 404 as previously described (see step [8] of FIG. 4). The further chemical product data associated with the decentral identifier may be accessed via a decentral data consuming network node as described in relation to FIG. 9.

FIG. 5A and FIG. 5B illustrate a part of a chemical production 204 producing coating materials 206 from different raw materials 202. The chemical production 204 may be a chemical production network as described in relation to FIG. 2A and FIG. 2B.

The chemical production 204 comprises a system boundary. In this example, the raw material streams form the entry point into the chemical production 204. The chemical products 206 produced from the chemical production form the exit point out of the chemical production. The chemical production may be a coating material production and the chemical products 206 exiting the chemical production may be coating materials. The chemical production may include different production chains for different coating materials, such as pigmented coating materials and unpigmented coating materials. The production of pigmented coating materials may again be performed using different production chains, each production chain being assigned to the production of a specific type of pigmented coating material.

The chemical production 204 may comprise a resin production 502. The resin production 502 may comprise one or more resin production units, each unit producing a specific resin, and one or more material storages associated with each production unit. The resins exiting the resin production 502 may be regarded as intermediates. Resins produced by the resin production 502 may include polymers, such as film-forming polymers. Examples of film-forming polymers include alkyd resins, polyester resins, polyimides, silicone resins, novolak resins, urea resins, melamine resins, amino resins, polyurethane resins, epoxy resins, polyolefin resins, polyvinyl resins, polyacrylic resins, polymethacrylic resins, or copolymers thereof.

The resin production may be fed by a raw material stream 202 containing the materials necessary to produce the respective resin. The raw material stream may include one or more monomers or pre-polymers necessary to produce the respective resin. Monomers may include low molecular weight compounds (e.g. less than 1000 g/mol) comprising at least one functional group capable of reacting with a further functional group. Pre-polymers may include polymeric materials (i.e. materials being obtained by reacting at least two monomeric materials). The raw material stream may further include solvents and further additives necessary to produce the respective resins, such as radical starters, surfactants, neutralizing agents, etc. The respective resin may be produced by an appropriate chemical polymerization reaction from the raw material stream. The respective resin may be produced batch-wise or in a continuous manner using appropriate resin production units, such as reactors.

The resin production unit may be connected to pipes or lines which allow the supply of different raw materials stored in a material storage, such as a tank. The supplied amount of inbound material 202 may be determined using a sensor and the sensor data may be used by the operating system 208 described in relation to FIG. 2A to control the respective raw material feed. The resin production unit may also allow addition of raw materials having a defined weight, for example weighted quantities of solids or liquids which are supplied as discretely packaged products, such as in bottles or bags.

The resin production may comprise a polymerization step. The resin production may further include a neutralization step and/or a step removing organic solvents used in the polymerization step. The produced resin may be supplied to a material storage, such as a tank.

The resin production 502 may be controlled by the operating system 208 described in relation to FIG. 2A based on received material demand data or on received bills of materials.

The chemical production 204 may further comprise a pigment paste preparation 504. The pigment paste preparation 504 may be fed by a raw material stream containing the materials necessary to produce the respective pigment pastes. Raw materials may include resins(s) produced by the resin production 502 and pigments, for example color and/or effect pigments. Raw materials may further include fillers, additives and solvents. The pigment paste preparation 504 may be connected via pipes with the resin production 502 to allow supply of produced resins. The pigment paste preparation 504 may be connected to material storage via lines or pipes and the amount of respective raw material may be supplied using sensors to allow the operating system 208 to control the feed of raw materials based on sensor data. The pigment paste preparation 504 may also allow addition of raw materials having a defined weight, for example weighted quantities of solids or liquids which are supplied as discretely packaged products, such as in bottles or bags. The pigment paste preparation 504 may be controlled by the operating system 208 described in relation to FIG. 2A based on received material demand data or on received bills of materials.

The pigment paste preparation 504 may comprise mixing units (also denoted as dispersing units), milling units and material storage. The mixing units and milling units may be connected with pipes or lines to allow passage of the mixed material to the milling unit(s). The raw material stream may be supplied to one or more mixing units for mixing. Afterwards, the mixed material may be supplied to one or more milling units to prepare the respective pigment paste. The prepared pigment paste may be adjusted to standardized tinting strength and supplied to a material storage.

The chemical production 204 may further comprise a base varnish production 506. The base varnish production 506 may include one or more mixing units and a material storage. The base varnish production 506 may be fed by a raw material stream containing the materials necessary to produce the respective base varnish. Raw materials may include resins(s) produced by the resin production 502 and pigment pastes produced by pigment paste preparation 504. Further raw materials may include solvents and additives, such as thickening agents, anti-settling agents, anti-sagging agents, light stabilizers, anti-foaming agents, adhesion promoters, etc. The base varnish production 506 may be connected via pipes with the resin production 502 and the pigment paste preparation 504 to allow supply of produced resins and pigment pastes. The base varnish production 506 may be connected to material storage via lines or pipes and the amount of respective raw material may be supplied using sensors to allow the operating system 208 to control the feed of raw materials based on sensor data. The base varnish production 506 may also allow addition of raw materials having a defined weight. The base varnish production 506 may be controlled by the operating system 208 described in relation to FIG. 2A based on received material demand data or on received bills of materials.

The chemical production 204 may further comprise a coating material production 508. The coating material production 508 may include one or more mixing units, one or more filtration units and one or more material storages. The coating material production 508 may be fed by a raw material stream containing the pigment paste(s) produced by the pigment paste preparation 504 and the base varnish produced by the base varnish production 506. The coating material production 508 may be connected via pipes with the resin production 502 and the pigment paste preparation 504 to allow supply of produced resins and pigment pastes. The coating material production 508 may be connected to material storage via lines or pipes and the amount of respective raw material may be supplied using sensors to allow the operating system 208 to control the feed of raw materials based on sensor data. The coating material production 508 may be controlled by the operating system 208 described in relation to FIG. 2A based on received material demand data or on received bills of materials.

The chemical production may further include a packaging unit (not shown) for packaging the coating material(s) produced by coating material production 508. The coating materials may be packaged into containers and the containers be stored in a material storage. The containers may comprise a sensor device, such as sensor device 610 illustrated in FIGS. 6A to 6C.

FIG. 5A illustrates an embodiment for a system boundary of the chemical production, which includes the resin production 502. The raw materials stream forms the entry point into the chemical production. The coating materials form the exit point out of the chemical production.

FIG. 5B illustrates another embodiment for the system boundary of the chemical production 204, which excludes the resin production 502. The resin feed and the raw material feed form the entry point into the chemical production 204. The coating materials form the exit point out of the chemical production 204. The chemical productions and the system boundaries illustrated in FIG. 5A and FIG. 5B are examples and should not be considered limiting.

FIG. 6A illustrates an example of monitoring the quantity of the chemical product at the consumption location 404 via at least one sensor device. The quantity may be monitored as described in the context of FIG. 10 and FIG. 11A. The consumption location 402 may be a consumption location as described in relation to FIG. 4.

Chemical products 206 produced by a chemical production 204 (see for example FIG. 4) may be provided to the consumption location 404 as described in relation to FIG. 4. The provided chemical products 206 may each comprise a sensor device 608. The sensor device 608 may be connected to the packaging unit 606 associated with the chemical product 206. For instance, the sensor device 608 may be connected to a container comprising the chemical product as described in relation to FIG. 6B. The sensor device 608 may be configured to acquire data being indicative of the amount of chemical product present within the packaging unit. For instance, the sensor device may be configured to acquire data being indicative of the fill level of the chemical product within the container, for example by acoustically stimulating the container and acquiring the acoustic response being indicative of the fill level of the chemical product. The data acquired by each sensor device 608 may be gathered by quantity monitoring unit 212 via a communication interface, for example as described in relation to FIG. 6B and FIG. 11A. The data being indictive of the amount of chemical product present within the packaging unit may be acquired at predefined time points or may be acquired upon detection of predefined incidents. For instance, the sensor device 608 may be configured to determine the location of the packaging unit it is attached to and the determined location may be used to determine whether or not to acquire data being indicative of the amount.

The provided chemical products 206 may be stored in a product storage 602, such as a warehouse, associated with the consumption location prior to consuming the chemical products within the consumption location 404. Consuming the chemical product may include using the chemical product to produce further products 402 (see FIG. 4). The chemical product may be dosed from the packaging unit into the respective process at the consumption location. For instance, the packaging unit 606 comprising the sensor device 608 may be connected via a line 610 to a robot 604 configured to apply the chemical product, for example to a substrate. The total amount of chemical product within a packaging unit or only part of the amount may be used within a process. The chemical product may be filled from the packaging unit into a tank connected to the plant. During consumption of the chemical product, the sensor device 608 may acquire data being indicative of the amount at predefined time points, upon detection of predefined incidents or upon request of the quantity monitoring unit 212. This may reduce energy consumption of the sensor device 608, thus increasing the maintenance intervals of the sensor devices 608. For instance, the sensor device 608 may be configured to detect movement of the packaging unit and may acquire data being indicative of the amount after detecting such movement and/or the quantity monitoring unit 212 may send a signal to the sensor device 608 and the sensor device 608 may acquire data being indicative of the amount in response to receiving said signal from the quantity monitoring unit 212. This may allow the quantity monitoring unit 212 to determine the current quantity of the chemical product, for example upon request of the operating system of the chemical production (not shown).

The quantity monitoring unit 212 may be part of the operating system of the chemical production 204 (see FIG. 2A) or may be associated with the operating system of the chemical production 204 (see FIG. 2B), as described in relation to FIG. 4. The quantity monitoring unit 212 may be configured to communicate with each sensor device 608, for example via a communication interface (see also FIG. 6B). For instance, the quantity monitoring unit 212 may be configured to send data to each sensor device 608 and to receive data from each sensor device 608 (see also FIG. 6C). The quantity monitoring unit 212 may be configured to monitor the quantity of chemical product present at the consumption location (e.g. chemical product being present in a product storage 602 and/or chemical product being consumed within the consumption location), for example as described in relation to FIG. 4, FIG. 10 and FIG. 11A.

FIG. 6B illustrates an example of a system for monitoring the quantity of a chemical product via at least one sensor device 608. The quantity may be monitored as described in the context of FIG. 10 and FIG. 11A. The system comprises a packaging unit 606 containing the chemical product, a sensor device 608 and a quantity monitoring unit 212.

The packaging unit 606 may comprise a container, such as a metal or plastic container. The metal container may be a single-walled IBC (intermediate bulk container). The container may be present within a metal framework to allow for easy transportation and stacking of the container. The packaging unit may be a bottle, such as a plastic or glass bottle (not shown). The packaging unit may be a reusable packaging unit, i.e. said packaging unit may reused to package further chemical products. For instance, the packaging unit may be transferred-after consumption of the chemical product-to the chemical production producing the chemical product and may be used at the chemical production, optionally after cleaning, to package produced further chemical product. Use of reusable packaging units allows to save resources and avoids the generation of waste associated with the packaging units. The packaging unit 606 may be a bag, such as a plastic or paper bag (not shown). The packaging unit may not be a reusable packaging unit, i.e. the packaging unit may be destroyed upon consumption of the chemical product, for example by opening the packaging unit.

The packaging unit 606 may be filled with a liquid chemical product, such as a liquid coating composition, or a liquid chemical compound. The packaging unit may be filled with a solid chemical product, such as a solid plastic granulate.

The packaging unit 606 may comprise sensor device 608. The sensor device 608 may be physically coupled to any part of the packaging unit, such as the outside of the packaging unit. Physical coupling of the sensor device 608 to the packaging unit may be achieved by an attachment means, such as a metal bar clampable to the metal framework, comprising the sensor device 608. For instance, the sensor device 608 may be attached to the attachment means by means of a screw which can may also be used to ensure that the sensor device 608 is in contact with parts of the packaging unit, such as the outside of the container. The sensor device 608 may be removed from the attachment means by unscrewing the screw, thus allowing easy attachment and removal of the sensor device 608, for example during cleaning processes to avoid damage of the sensor device 608. The attachment means may be removable to avoid recertification of the packaging unit which may need to be performed in case the packaging unit, such as a container, is permanently modified, for example by permanently fixing the attachment means to the packaging unit or a part thereof, such as the container. The attachment means may comprise an identification tag having stored thereon data associated with the packaging unit, such as the packaging unit ID. The identification tag may be an NFC tag, such as an active or passive NFC tag. The identification tag may be attached to the attachment means permanently or may be detachable, such that it can be removed prior to cleaning processes to prevent destruction of the identification tag during the cleaning process.

The quantity monitoring unit 212 may be part of the operating system of the chemical production 204 (see for example FIG. 2A) or may be associated with the chemical production (see for example FIG. 2B). The quantity monitoring unit 212 may be a server device, such as a physical server or a cloud based server (e.g. a virtual server which runs within a cloud computing environment) as described in relation to FIG. 6C below. The quantity monitoring unit 212 may be configured to monitor the quantity of the chemical product present within the packaging unit as described in relation to FIGS. 4, 10 and 11A. The quantity monitoring unit 212 may be configured to determine data being indicative of the quantity of a chemical product being present within a packaging unit based on data gathered from the sensor device 608. Data being indicative of the quantity of the chemical product being present within a packaging unit may include the fill level. The fill level may be indicated in volume or in weight. Data being indicative of the quantity of the chemical product may be determined from acoustical data gathered by sensor device 608 in response to an acoustical response induced by sensor device 608 to the outside of the packaging unit, for example as described in patent application WO 2022/233596 A1. Data being indicative of the quantity of the chemical product may be determined from acoustical data gathered by sensor device 608 in response to an acoustical response induced by sensor device 608 to the outside of the packaging unit by generating acoustic behaviour data of the measured acoustical behaviour by determining at least one root mean square (RMS) value for at least one time interval, and comparing the generated acoustical behaviour data to reference measurement data containing reference acoustical behaviour data associated with the container containing one or more defined amounts of a defined compound, for example as disclosed in unpublished patent application EP23151905.9.

The quantity monitoring unit 212 may be connected to the sensor device 608 via cellular communication interfaces 636, 638 making use of a mobile radio tower 634. The cellular communication interface 636 may be a LPWAN technology. LPWAN allows reliable data transmission over long ranges and under difficult conditions and requires low power consumption for data transfer. This allows to use a quantity monitoring unit 212 which is not in close proximity to the sensor device 608, thus rendering it possible to centralize data processing and to use a single quantity monitoring unit 212 for the processing of data gathered from multiple sensor devices 608 from various locations. Moreover, the use of LPWAN allows data transmittal with low power consumption, thus reducing the maintenance intervals of the sensor device 608 to exchange the batteries. The cellular-based communication interface 636 may exceed the coverage capability of 900 MHz communication systems and may eliminate the need to integrate with a WiFi network or other LAN and any associated issues, e.g. firewalls, changing passwords, or different SSIDs.

The sensor device 608 may be configured to communicate with a WiFi hotspot or any device capable of using ISM technology 632 via communication interface 640 and/or with a global navigation satellite system 630 via communication interface 642. This communication may be used to acquire data on the location of the packaging unit. The sensor device 608 may be pre-programmed with at least one cellular ID, Wi-Fi network ID, ISM location and/or GPS location, and the processor of the sensor device 608 may determine when one of these parameter values has been detected via the communication interface(s) present in the sensor device 608. The sensor device 608 may determine its location based on the detected satellites using GPS technology. Data on the location of the packaging unit 606 may be determined based on the WiFi or ISM frequency detected by the sensor device 608 in combination with a database comprising the frequencies associated with a consumption location. The sensor device 608 may use at least two different technologies to determine data on the location of the packaging unit 606 to ensure that data on the location can be obtained indoors as well as outdoors. Data on the location of the packaging unit 606 may be transmitted via communication interfaces 636, 638 to quantity monitoring unit 212.

The system may comprise a plurality of packaging units 606.1 to 606.n having attached thereto sensor devices 608.1 to 608.n. Each sensor device 608.1 to 608.n may transmit data via communication interfaces 636, 638 to the quantity monitoring unit 212 and the quantity monitoring unit 212 may then process all data gathered from said sensor devices (see also FIG. 6C). Data from sensor devices 608.1 to 608.n may be transmitted to different quantity monitoring units 212.1 to 212.n and further processed by these units.

FIG. 6C illustrates an example of a system for remotely monitoring the quantity of a chemical product 206 and managing packaging units of the chemical product. The system may comprise a quantity monitoring unit 212. The quantity monitoring unit 212 may be part of the operating system of the chemical production 204 (see for example FIG. 2A) or may be associated with the chemical production (see for example FIG. 2B). The quantity monitoring unit 212 may be a cloud-based server or a plurality of cloud-based servers of having coupled thereto a plurality of sensor devices 608. The quantity may be monitored as described in the context of FIG. 10 and FIG. 11A. The sensor devices 608 may be physically attached to the packaging units 606 containing the chemical product 206, for example as described in relation to FIG. 6B, and may be configured to acquire data being indicative of the quantity of chemical product within the packaging unit as described in relation to FIG. 6A.

Each of the sensor devices 608 may be coupled via communication interfaces 620, 622, 624, 626 to cloud quantity monitoring unit 212. At least part of the communication interfaces 620, 622, 624, 626 may represent gateways. At least two sensor devices 608 may be coupled via one gateway to the quantity monitoring unit 212 (not shown). The sensor devices 608 may be coupled directly to the quantity monitoring unit 212. In this case, the sensor devices 608 may be configured with any of the gateway functionality and components described herein and treated like a gateway by quantity monitoring unit 212, at least in some respects. Each gateway may be configured to implement any of the network communication technologies described herein in relation to the sensor device 608 so the gateway may remotely communicate with, monitor, and manage sensor devices 608. Each gateway may be configured with one or more capabilities of a gateway and/or controller as known in the state of the art and may be any of a plurality of types of devices configured to perform the gateway functions defined herein. To ensure security of the transmitted data, each gateway may include a trusted platform module or TPM (for example in a hardware layer of a controller). The Trusted Platform Module (TPM) may be used to encrypt data and to protect the integrity computer processor. The TPM may be used for any of a variety of functions such as, for example, creation of data for, and storage of credentials and secrets to secure communication with one or more networks (e.g., any of the networks described herein); creation of TPM objects, which are special encrypted data stored in the nonvolatile memory outside the TPM, that can only be decrypted through the TPM; creation of data to be communicated and stored as part of transaction records (e.g., blockchain records) or registers, signing of files to secure the integrity and authenticity of services, e.g., services described herein; enablement of functions like Over-the-Air (OtA) update of firmware, software and parameters of the sensor device 608; other functions; and any suitable combination of the foregoing. The TPM may be used, for example, to encrypt portions of communications from/to sensor devices 608 to/from gateways, to encrypt portions of such information received at a gateway unencrypted, or to provide secure communications between the quantity monitoring unit 212, gateways 620, 622, 624, 626 and sensor devices 608. For example, TPMs or other components of the system may be configured to implement Transport Layer Security (TLS) for HTTPS communications and/or Datagram Transport Layer Security (DTLS) for datagram-based applications. Furthermore, one or more security credentials associated with any of the foregoing data security operations may be stored on a TPM. A TPM may be implemented within any of the gateways, sensor devices or servers in the quantity monitoring unit 212, for example, during production, and may be used to personalize the gateway or the sensor device. Such gateways, sensor devices and/or servers may be configured (e.g., during manufacture or later) to implement cryptographic technologies known in the state of the art, such as a Public Key Infrastructure (PKI) for the management of keys and credentials.

Each gateway connecting a sensor device 608 to the quantity monitoring unit 212 or each gateway present within a sensor device 608 may be configured to process data received from a sensor device 608, including analyzing data that may have been generated or received by the sensor device, and providing instructions to the sensor device. In addition, each gateway may be configured to provide one or more functions pertaining to commissioning, filling, cleaning, incoming good inspections, and certification (e.g., after 2 years), consumption and other processing of packaging units. For this purpose, each gateway may be configured with software encapsulating such capability. Sensor devices connected via a communication interface directly to the quantity monitoring unit 212 may be configured to process data and perform further functions described above. For this purpose, the respective sensor device(s) may be configured with software encapsulating such capability. By performing such processing at one or more gateways, and/or at the sensor devices themselves, as opposed to in a more centralized fashion on one or more servers in the quantity monitoring unit 212, the system may implement and enjoy the benefits of more distributed edge-computing techniques.

The quantity monitoring unit 212 may comprise two layers, namely an application layer 614 containing one or more applications 612 and a service layer 618 containing one or more databases 616. The application as well as the services layer may each be implemented using one or more servers in the quantity monitoring unit 212. The quantity monitoring unit 212 may comprise more or less layers. The service layer 618 may include, for example, the following databases 616: a transaction database, a packaging unit database, a packaging unit contents database, and lifecycle management database.

The transaction database may include one or more transaction records involving packaging units managed by the system. For example, transaction records may involve blockchain technology and the blockchain may serve as a secure transaction register for the system. Transactions may include any commercial transaction involving one of the managed packaging units or other status information not associated with a commercial transaction. Further, the data stored within each of the other databases 616 within the services layer 618 may be stored as one or more transaction records and may be part of the transaction register for the system.

The packaging unit database may include information about packaging units managed by the system such as, for example, mechanical specifications, geometries, date of creation, maintenance intervals, last inspection, material composition and other information.

The packaging unit contents database may include data about the chemical product (e.g., liquids, bulk solids, powders) contained in the packaging unit being managed such as, for example, ingredients, chemical composition, classification (e.g., pharmaceutical, beverage, food), an ATEX classification of the packaging unit's contents or intended contents, regulatory-related information, properties of the packaging unit and other information collected over time, and other information about the chemical product. Properties of the packaging unit may include physical properties associated with a packaging unit, such as, for example, climate conditions, location, weight, and fill level, a maximum fill level/maximum quantity of a packaging unit, as well as other properties. For a given packaging unit, the information stored in the packaging unit database and/or the packaging unit contents database may include the same information as is stored in the packaging unit itself, which in combination with the information about the packaging unit itself may be considered a digital representation of the packaging unit, e.g., a digital twin.

The lifecycle management database may store information about the states, rules, algorithms, procedures, etc. that may be used to manage the packaging units throughout the stages of their lifecycle. For example, a lifecycle of a reusable packaging unit, such as a container, may include the following stages: packaging unit production state, packaging unit preparation state, packaging unit filling state, packaging unit transport state, packaging unit use stage (i.e. consumption of chemical product contained in packaging unit), packaging unit maintenance state, packaging unit disposal state. A lifecycle of a non-reusable packaging unit may include the following states: packaging unit production state, packaging unit preparation state, packaging unit filling state, packaging unit transport state, packaging unit use stage (i.e. consumption of chemical product contained in packaging unit), packaging unit disposal state.

Information stored in the packaging unit database and/or packaging unit contents database may be retrieved by sensor device(s) 608 via communication interfaces 620, 622, 624, 626 upon physical coupling of the sensor device(s) 608 to the container (see FIG. 6A). After physical coupling, the packaging unit ID may be retrieved by means of the sensor device(s) 608 and may be used to obtain information stored in the packaging unit database and/or packaging unit contents database which is associated with the packaging unit ID. The packaging unit ID may be stored on a tag present on the attachment means as described in relation to FIG. 6B.

The transformation layer 614 may include any of a variety of applications that utilize information and services related to packaging unit management, including any of the information and services made available from the services layer 618. The transformation layer 614 may include: an inventory application, an order management application, further applications, or any suitable combination of the foregoing.

The inventory application may provide an inventory of packaging units managed within the system, including properties (e.g., characteristics) about each packaging unit in the system, and the contents thereof, including the current state of the packaging unit within its lifecycle, the current quantity of chemical product contained in the packaging unit, current location (e.g., one or more network identifiers for a mobile telephony network, Wi-Fi network, ISM network or other) and any other properties corresponding to a packaging unit described herein. The inventory of packaging unit may be a group (e.g., “fleet”) of packaging units owned, leased, controlled, managed, and/or used by a chemical production.

The order management application may manage packaging unit orders. The order management application may maintain information about all past and current container orders of a chemical production and process such orders. The order management application may be configured to automatically order new packaging units based on packaging unit status information received from sensor devices physically coupled to packaging units (e.g., via one or more gateways or directly from the sensor device itself). For example, the application may be configured to compare one or more predefined thresholds, e.g., of damaged packaging units, disposed packaging units, packaging units available for filling etc., to the current quantity of packaging units. The current quantity of packaging units may be retrieved from ordering information associated with ordering packaging units and data associated with the consumption of packaging units. The ordering information may be provided by the operating system of the chemical production. The data associated with the consumption of packaging units may be acquired from a filling line, from data acquired at a storage location and/or from order data associated with the ordering of chemical product by the consumption location or the operating system of the consumption location. The applications may be configured via interfaces to interact with other applications within the application layer 616, including each other. These applications or portions thereof may be programmed into gateways and/or sensor devices as well.

Packaging unit information may be communicated between components of the system, including sensor devices, gateways, and components of the quantity monitoring unit 212, in any of a variety of ways. Such techniques may involve the transmission of packaging unit information in transaction records, for example using blockchain technology. Such transaction records may include public information and private information, where public information can be made more generally available to parties, and more sensitive information can be treated as private information made available more selectively, for example, only to certain packaging unit producers and/or consumption locations. For example, the information in the transaction record may include private data that may be encrypted using a private key specific to a packaging unit and/or sensor device and may include public data that is not encrypted. The public data may also be encrypted to protect the value of this data and to enable the trading of the data, for example, as part of a smart contract. The distinction between public data and private data may be made depending on the data and the use of the data.

The number of communications between components of the system may be minimized, which in some embodiments may include communicating data from sensor devices to the quantity monitoring unit 212 according to a predefined schedule, in which gateways are allotted slots within a temporal cycle during which to transmit data (e.g., transmit data from sensor device 608 to quantity monitoring unit 212 or instructions from quantity monitoring unit 210 to sensor device(s) 608) to/from the quantity monitoring unit 212. Acquired data may be collected over a predetermined period of time by the sensor device and grouped into a single transaction record prior to transmittal.

FIG. 7 shows an example of ID-based owner data 702, ID-based passport data or access data 704 and a decentralized identity manager 706.

The ID may be a decentralized ID (DID). The ID-based passport data may be a DID document 704 associated with the DID. The ID-based owner data 702 may include an ID associated with a subject such as chemical product data and may include one or more authentication mechanism(s). The ID-based owner data 702 may include owner data that is electronically owned and controlled by the DID owner. In this context electronically owned may refer to data that is stored in an owner repository or wallet. Such data may be securely stored and/or managed on an organizational server or client device. The ID-based owner data 702 may include a DID, a private key and a public key. The ID-based owner may own and control the DID that represents an identity associated with the DID subject, a private key and public key pair that are associated with the DID. DID may be understood as an identifier and authentication information associated with or uniquely linked to the identifier.

The DID subject may be a raw material, a basic substance, a chemical product, or an end product. The DID subject may be a machine, a system, or a device used for producing the raw material, the basic substance, the chemical product, the intermediate product, or the end product, or a collection of such machine(s), device(s) and/or system(s). The DID owner may be a supply chain participant or a manufacturer such as a chemical manufacturer producing chemicals. The DID owner may be an upstream participant in the supply chain of the chemical manufacturer such as a supplier that supplies raw chemical products or precursors to produce the chemical product. The DID owner may be a downstream participant in the supply chain of the chemical manufacturer such as a customer that consumes chemical products to produce an intermediate product, the component, the component assembly or the end product. The DID owner may be any participant of the supply chain including raw chemical product supplier, intermediate chemical products manufacturer, intermediate part manufacturer, component manufacturer, component assembly manufacturer or end product manufacturer.

The DID may be any identifier that is associated with the DID subject and/or the DID owner. Preferably, the identifier is unique to the DID subject and/or DID owner. The identifier may be unique at least within the scope in which the DID is anticipated to be in use. The identifier may be a locally or globally unique identifier for the raw material, the precursor, the basic substance, the chemical product, the intermediate product, the component, the component assembly, the end product or a collection thereof; the machine, the system, or the device used for producing the raw material, the basic substance, the chemical product, the intermediate product, the component, the component assembly or the end product, or the collection of such machine(s), device(s) and/or system(s); the chemical manufacturer producing chemicals, the upstream participant in the supply chain of the chemical manufacturer, the downstream participant in the supply chain of the chemical manufacturer or a collection thereof; any participant of the supply chain including raw chemical product supplier, intermediate chemical products manufacturer, intermediate part manufacturer, component manufacturer, component assembly manufacturer or end product manufacturer or a collection thereof.

The DID may be a Uniform Resource Identifier (URI) such as a Uniform Resource Locator (URL). The DID may be an Internationalized Resource Identifier (IRI). The DID may be a random string of numbers and letters for increased security. In one embodiment, the DID may be a string of 128 letters and numbers e.g. according to the scheme did: method name: method specific-did such as did: example: ebfeb1f712ebc6f1c276e12ec21. The DID may be decentralized ID independent of a centralized, third party management system and under the control of the DID owner.

In one example, the chemical product passport as DID document 704 may be associated with the DID. Accordingly, the chemical product passport may include a reference to the DID, which is associated with the DID subject that is described by the DID document. The DID document may also include an authentication information such as the public key. The public key may be used by third-party entities that are given permission by the DID owner/subject to access information and data owned by the DID owner/subject. The public key may also be used for verifying that the DID owner, in fact, owns or controls the DID. The DID document may include authentication information, authorization information e.g. to authorize third party entities to read the DID document or some part of the DID document e.g. without giving the third party the right to prove ownership of the DID.

The chemical product passport may include one or more representations that digitally link to the respective data, such as the chemical product data associated with the further chemical product, e.g. by way of service endpoints. A service endpoint may include a network address at which a service operates on behalf of the DID owner. In particular, the service endpoints may refer to services of the DID owner that give access to the chemical product data. Such services may include services to read or analyze the chemical product data. The chemical product data may include chemical product declaration data, chemical product safety data, certificate of analysis data, emission data, product carbon footprint data, product environmental footprint data, chemical product specification data, product information, technical application data, production data or combinations thereof.

The chemical product passport may include various other information such metadata specifying when the chemical product passport was created, when it was last modified and/or when it expires.

In another example, the DID document 704 may represent a digital representation pointing to the chemical product passport or a part thereof. The digital representation may include one or more representations for accessing the chemical product data or parts thereof. The representations may include service endpoint(s). The service endpoint(s) may be associated with or represent decentral providing network node(s) associated with a data owner of the chemical product passport. The decentral providing network node(s) may have access to a data base storing the chemical product passport. This way, access to the chemical product passport or parts thereof may be controlled by the data owner of the chemical product passport, such as the chemical product producer producing the chemical product associated with the chemical product passport.

The DID and the DID document 704 may be associated with a data registry node 706 such as a centralized data service system or a decentralized data service system, e.g. a distributed ledger or blockchain or a decentralized file system. Possible blockchain systems include Quorum, Hyperledger Fabric. The distributed ledger or blockchain may be used to store a representation of the DID that points to the DID document. A representation of the DID may be stored on distributed computing nodes of the distributed ledger or blockchain. For example, DID hash may be stored on multiple computing nodes of the distributed ledger and point to the location of the chemical product passport. In some embodiments, the DID document may be stored on the distributed ledger. Alternatively, in other embodiments the DID document may be stored in a data storage that is associated with the distributed ledger or blockchain or a decentralized file system.

The distributed ledger or blockchain may be any decentralized, distributed network that includes various computing nodes that are in communication with each other. For example, the distributed ledger may include a first distributed computing node, a second distributed computing node, a third distributed computing node, and any number of additional distributed computing node. The distributed ledger or blockchain may operate according to any known standards or methods for distributed ledgers. Examples of conventional distributed ledgers that correspond to the distributed ledger or blockchain include, but are not limited to, Bitcoin [BTC], Ethereum, and Litecoin.

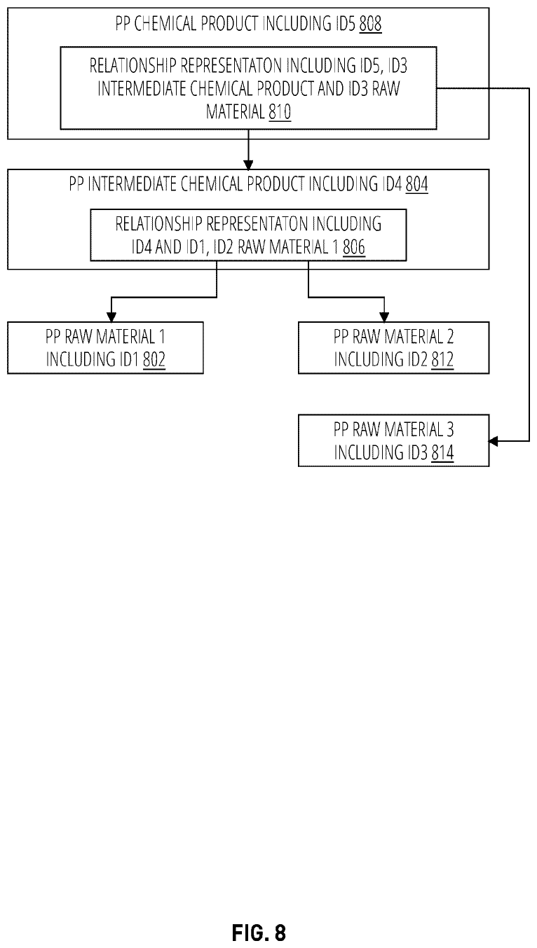

FIG. 8 show an example of relationships between chemical product passports and associated relationship representations specifying relationships between a chemical product and materials used to produce the chemical product. The chemical product may be chemical product 206 produced by chemical production 204 (see for example FIG. 4). The chemical product may be further chemical product produced by chemical production in response to the quantity of chemical product present at the consumption location having reached or being below a given minimum threshold (see for example FIG. 4).

The chemical product passport (PP) of the chemical product 808 may include a decentral identifier ID5, such as described in the context of FIG. 2A, and data related to chemical product data associated with the chemical product. The chemical product passport (PP) of the chemical product may include a relationship representation 810 containing the decentral identifier ID5, a decentral identifier ID4 associated with an intermediate chemical product used to produce the chemical product and a decentral identifier ID3 associated with a third raw material used to produce the chemical product. The relationship representation may further include decentral identifiers associated further raw materials and/or intermediate products used to produce the chemical product (not shown). The relationship representation 810 may be associated with data related to the relationship representation. Said data may be used by a decentral network node to gather the relationship representation from the decentral data consuming network node associated with said relationship representation (e.g. associated with a storage environment storing said relationship representation). The data related to the relationship representation may include a decentral relationship representation identifier and a digital representation pointing to said relationship representation. The data related to the relationship representation may be associated with data related to the chemical product passport (PP). Data related to the chemical product passport may include the decentral identifier and a digital representation pointing to the chemical product data or parts thereof.

Decentral identifier ID4 contained in relationship representation 810 may be associated with a product passport (PP) of the intermediate chemical product 804. The product passport of the intermediate chemical product 804 may include the decentral identifier ID4, such as described in the context of FIG. 3, and data related to intermediate chemical product data. The product passport (PP) 804 may include a relationship representation 806 containing decentral digital twin identifier ID4, a decentral identifier ID1 associated with a first raw material used to produce the intermediate chemical product and a decentral identifier ID1 associated with a first raw material used to produce the intermediate chemical product. The relationship representation may further include decentral identifiers associated with the further raw materials or intermediate chemical products used to produce the intermediate product (not shown). The relationship representation 810 may be associated with data related to the relationship representation as previously described. Said data may be used by the decentral network node to gather the relationship representation from the decentral data consuming network node associated with said relationship representation as previously described.

Decentral identifier ID3 contained in relationship representation 810 may be associated with the material passport (PP) of raw material 3 814. The material passport (PP) of raw material 3 may include the decentral identifier ID3, such as described in the context of FIG. 2A, and data related to the raw material data associated with the raw material 3.

Decentral identifier ID2 contained in relationship representation 806 may be associated with the material passport (PP) of raw material 2 812. The material passport (PP) of raw material 2 may include the decentral identifier ID2, such as described in the context of FIG. 2A, and data related to the raw material data associated with the raw material 2.

Decentral identifier ID1 contained in relationship representation 806 may be associated with the material passport (PP) of raw material 1 802. The material passport (PP) of raw material 1 may include the decentral identifier ID1, such as described in the context of FIG. 2A, and data related to the raw material data associated with the raw material 1.

Linking of passports(s) via relationship representation(s) hence allows to mirror the supply and production chain of a chemical product, thus allowing to create, using said relationship representations, a bill of material tree for said chemical product with the chemical product representing the top node of the tree and raw materials used in the production of the chemical product representing the leaf nodes of the tree. The bill of material tree may be used to efficiently determine one or more particular materials used during the production of the chemical product.

FIG. 9 shows a schematic illustration of providing access by a decentral data providing network node to chemical product data or a part thereof associated with a chemical product using a chemical product passport associated with said chemical product. The chemical product may be a further chemical product produced by chemical production 204 as described in the context FIG. 4. Access to the chemical product data or the part thereof associated with the chemical product may be requested by a decentral data consuming network node. The chemical product data may include the decentral identifier and at least one measured physical and/or chemical property of the chemical product and/or at least one physical and/or chemical property determined from collected data associated with the production of the further chemical product.

A chemical product passport may be generated upon or after production of the further chemical product, for example as described in the context of FIG. 10 and FIG. 12. The chemical product passport may be associated with the chemical product data or the part thereof. The chemical product passport may contain the decentral identifier and at least one digital representation pointing to the chemical product data or a part thereof. An example of such a chemical product passport is illustrated in FIG. 7. The chemical product passport may further include or relate to authentication and/or authorization information linked to the decentral identifier. The authentication and/or authorization information may be provided for authentication and/or authorization of the decentral data providing network node 924 and/or the decentral data consuming network node 912. The chemical product passport may be provided to a decentral registry 908. Decentral access element registry 908 may store product passports(s) and associated digital representation(s). The chemical product passport may contain the decentral identifier and chemical product data. The chemical product passport may further include or relate to authentication and/or authorization information linked to the decentral identifier. The chemical product passport may be associated with a digital representation (e.g. access element) pointing the chemical product data or parts thereof. The decentral identifier included in the chemical product passport may be linked to the digital representation. The digital representation may include one or more representation(s) for accessing the chemical product data or parts thereof. An example of such a digital representation is illustrated in FIG. 7. The digital representation may be provided to a decentral registry 908. Decentral access element registry 908 may store digital representation(s) associated with such chemical product passports.

The decentral data providing network node 924 may be associated with the chemical production 204 producing the further chemical product(s). The decentral data providing network node 912 may be associated with a data owner. The data owner may be the chemical production. The data owner may be the entity operating the chemical production. The chemical production may be a chemical production as described in relation to FIG. 5A or FIG. 5B. The chemical production may be associated with an operating system as described in relation to FIG. 2A and FIG. 2B. The decentral data consuming network node 912 may be associated with the consumption location 404 consuming the chemical product(s) provided by the chemical production, for example as described in the context of FIG. 4. The chemical product 206 as produced by the chemical production network 204 may be provided in association with the chemical product passport to entry points of the consumption location 404 and may be used in the consumption location 404 to produce one or more product(s) 402 from the chemical product(s). Product(s) 402 produced by the consumption location 404 may be provided on exit points of the consumption location 404. The chemical product(s) and further chemical product(s) 206 produced by chemical production 204 may include pigment pastes, base varnishes, thinners, rheology modifying agents and coating materials. Products 402 produced by the consumption location 404 may include coated substrates, components or other chemical product(s).

The chemical product(s) provided to the consumption location 404 may comprise a physical identifier connected to the chemical product(s). The physical identifier may be physically attached to the respective chemical product or a component thereof, such as a packaging unit containing the chemical product, via an identifier element, such as markers embedded in the chemical product, a bar code, a QR-Code, a tag like a RFID tag or similar physical arrangement that allows to digitally identify the chemical product. The physical identifier may have encoded the decentral identifier. The physical identifier may have encoded a chemical product identifier associated with the chemical product.

At the consumption location 404 a code reader 902 may read the physical identifier. The code reader 902 may be a smartphone running a code reading application, such as a QR code reader app. The data obtained by the code reading application may be used to determine the decentral identifier. The data obtained by the code reading application may be used to determine the chemical product identifier. The data obtained by the code reading application may be used to determine the digital representation(s). The decentral identifier, chemical product identifier and digital representation(s) may be determined by code reader 902. For instance, the decentral identifier determined by the code reader 902 may be a DID and the code reader 902 may be configured to retrieve the associated DID document (see FIG. 7) containing the decentral identifier and the digital representation(s), for example using a DID resolver). In another instance, the chemical product identifier may be determined by code reader 902 and may be used to retrieve the decentral identifier and associated digital representation(s), for example from a database, such as decentral registry 908. Hence, code reader 902 may be configured to retrieve the chemical product passport or access element containing the decentral identifier and digital representation(s) from decentral registry 908. Code reader 902 may be configured to provide the decentral identifier to a database 906 associated with the consumer of the chemical product. Code reader 902 may be configured to provide the determined decentral identifier and digital representation(s) to decentral data consuming network node 912.

Code reader 902 may be configured to display determined/retrieved data on a user interface as illustrated by reference sign 904. The user interface may display the determined decentral identifier (PP identifier), and the determined digital representation(s) (DT location). The user interface may further display the determined chemical product identifier (CP identifier). The user interface may also allow to initiate retrieval of the chemical product data or a part thereof based on the decentral identifier and the digital representation(s) as described in the following. This process may be initiated by the button denoted “Access DT”. Upon pressing said button, code reader 902 may send a request to access the chemical product data or the part thereof to decentral data consuming network node 912.

The decentral data consuming network node 912 associated with the consumption location 404, such as the operating system of the consumption location 926, may generate a request to access the chemical product data or a part thereof. Decentral data consuming network node 912 may generate the request based on the data gathered from code reader 902. For instance, decentral data consuming network node 912 may generate the request based on the decentral identifier gathered from code reader 902. Data consuming network node 912 may generate the request based on the decentral identifier provided to database 906. For example, decentral data consuming network node 912 may be configured to gather the decentral identifier and digital representation(s) from decentral registry 908 based on the identifier stored in database 906. Data consuming network node 912 may generate the request based on the data gathered from operating system 924. The request generated by decentral data consuming network node 912 may include the decentral identifier and a decentral participant identifier associated with decentral data consuming network node 912. Decentral data consuming network node 912 may be configured to determine the decentral data providing network node 924 associated with the chemical product data based on the digital representation(s) gathered from code reader 902, operating system 926 or from decentral registry 908.

Decentral data consuming network node 912 may sent the request to access the chemical product data or a part thereof to the determined decentral data providing network node 924 as signified by arrow 910. The digital twin provider 424 may be associated with the chemical product producer. The decentral data providing network node 924 may be associated with the chemical production 204 producing the chemical product. The decentral data providing network node 924 may be associated with the data owner of the chemical product data, such as the chemical product producer. The decentral data providing network node 924 may be associated with a data base 922 storing the chemical product data. In addition to the request, authentication and/or authorization information may be provided by decentral data consuming network node 912.

The request may be authenticated, for example using a certificate based authentication mechanism. The request may be validated by the decentral data providing network node 924, for example by retrieving access rules from a database of the decentral data providing network node 924 based on the decentral participant identifier and the decentral identifier contained in the received request. At least part of the retrieved access rules may be applied to the received request. This allows to filter decentral data consuming network nodes requesting access based on the decentral participant identifier(s) associated with said network nodes. If the request is not valid, e.g. if the decentral data consuming network node is not authorized to access the chemical product data, the peer-to-peer communication channel will be terminated by decentral data providing network node 924 and no chemical product data will be provided.

If the request is valid, decentral data providing network node 924 may initiate contract negotiations with decentral data consuming network node 912. Decentral data providing network node 924 may provide an electronic contract to decentral data consuming network node 912. The electronic contract may include access rule(s) associated with the decentral identifier. This allows the data user, e. g, chemical product consumer, to determine access and usage conditions associated with the desired data. Decentral data providing network node 924 and decentral data consuming network node 912 may be configured to negotiate an electronic contract and to sign the negotiated electronic contract. Use of the electronic contract ensures that the decentral data consuming network node 912 and further systems handling the chemical product or a part thereof are complying to access rule(s) associated with the chemical product data or the part thereof. Upon signature of the electronic contract, decentral data providing network node 924 may gather the chemical product data or a part thereof stored in DT storage 922 based on the decentral identifier contained in the received request as designated by arrows 914 and 916. Decentral data providing network node 924 may apply determined access rule(s) to the gathered chemical product data or the part thereof. Afterwards decentral data providing network node 924 may provide the chemical product data or parts thereof according to the applied access rule(s) to the decentral data consuming network node 912 as signified by arrow 918. This way, the chemical product data may be provided to the data consumers under control of the data owner of the chemical product data.

The digital twin provided by decentral data providing network node 924 may be stored in database 906 associated with the decentral data consuming network node 910 according to the access rule(s) as signified by arrow 920.

Through the decentral identifier, chemical product data can be uniquely associated with the chemical product. Through the decentral network, the chemical product data or a part thereof may be transferred between the producer of the chemical product and the consumer of the chemical product in a standardized and secure way, allowing the producer of the chemical product to control access to the chemical product or the part thereof by multiple decentral data consuming network nodes existing within the decentral network. This way, the chemical product data or the part thereof can be shared with unique association to the chemical product and without central intermediary directly between the participants of the chemical product ecosystem. This allows for transparency on the chemical product data for consumers of the chemical product while avoiding the sharing of such chemical product data with unauthorized downstream participants, such as participants not using the chemical products.

The generated chemical product passport associated with said digital twin allows to share chemical product data under simplified and customizable conditions without compromising data security and data sovereignty.

FIG. 10 illustrates a flow chart of a method for controlling the production of a chemical product by a chemical production in accordance with an example embodiment of the present disclosure. The method may be performed by the operating system of the chemical production, such as operating system 208 described in the context of FIGS. 2A, 2B and 4.

In block 1002, a chemical product may be produced from one or more inbound materials using the chemical production 204. The chemical production may be a chemical production described in the context of FIG. 2A, 2B, 5A or 5B. At least part of the produced chemical product may be provided to a consumption location, such as consumption location 404 described in the context of FIG. 4. The produced chemical product may be provided to the consumption location within packaging units. Each packaging unit may comprise a defined quantity of the chemical product. At least part of the packaging units may comprise sensor devices, such as sensor device 608 described in the context of FIG. 6A to 6C. The chemical product may be stored in a product storage 602 (see FIG. 6A) associated with the consumption location 404. The chemical product provided to the consumption location may be used to produce further products 402 as described in the context of FIG. 4.

In block 1004, data being indicative of the quantity of the chemical product at the consumption location may be gathered and may be compared to a predefined minimum threshold. Gathering the data and comparing the gathered data to a predefined minimum threshold may be performed, for example as described in the context of FIG. 11A and FIG. 11B. Block 1004 may be regarded as monitoring the quantity of the chemical product at the consumption location.

In block 1006, it may be determined whether the data gathered in block 1004 has reached or is below the predefined minimum threshold. If this is the case, the method may proceed to block 1008. Otherwise, the method may return to block 1004 and may continue to monitor the quantity of the chemical product present at the consumption location. Blocks 1004 and 1006 may be performed at predefined time intervals. Blocks 1004 and 1006 may be performed at regular time intervals to ensure a continuous monitoring of the quantity of the chemical product present at the consumption location.

In block 1008, production of a further chemical product may be triggered. The production may be triggered by the operating system of the chemical production. Triggering of the production may include generating chemical production data and producing further chemical product using the generated chemical production data. The chemical production data may be generated based on a chemical product identifier associated with the chemical product. The chemical production data may further be generated based on a consumption location identifier associated with the consumption location. Use of the consumption location identifier allows to generate chemical production data to tailor the production of the further chemical product to the needs of the consumption location. The chemical production data may specify the production chain(s) of the chemical production. The chemical production data may include a bill of materials for one or more production chain(s) of the chemical production. The chemical production data may include one or more recipe(s) specifying one or more inbound material(s) for production process(es) of the chemical production.

In block 1010, a request to provide a decentral identifier associated with chemical product data of the produced further chemical product and preferably a data owner may be received. The request may be received from a requestor, for example as described in the context of FIG. 13. The request may include data related to the chemical product data and/or an owner or product identifier associated with the chemical product data owner or the chemical product, respectively.

In block 1012, a chemical product passport including the decentral identifier and data related to the chemical product data may be generated and the decentral identifier included in said chemical product passport may be assigned to a physical identifier associated with the chemical product. The chemical product passport may be generated using the method described in the context of FIG. 12. The chemical passport may be generated by the apparatus described in the context of FIG. 13. The generated chemical passport may further include an owner identifier. The generated chemical product passport may relate to or include one or more authorization mechanisms or schemes associated with the decentral identifier and the data related to the chemical product data as previously described. The generated chemical product passport may relate to or include one or more authentication mechanisms or schemes associated with the decentral identifier and the data related to the chemical product data. A digital representation of the chemical product passport may be generated. The digital representation may include one or more representation(s) for accessing the chemical product passport or parts thereof. The digital representation may be linked to the decentral identifier included in the chemical product passport.

Assigning the decentral identifier to the physical identifier may be performed by an ID assignor as described in the context of FIGS. 2A, 2B, 3 and 13.

In block 1014, a defined quantity of produced further chemical product is provided to the consumption location 404, this block being generally optional. The defined quantity may be present within packaging units. The defined quantity may be determined based a predefined maximum threshold associated with said consumption location. The predefined maximum threshold may be associated with the maximum amount of chemical product that should be stored at the consumption location. The defined quantity may then be determined from data related to the remaining quantity and said maximum threshold. The defined quantity may be determined based on data related to the available storage space and the remaining quantity. This ensures that enough further chemical product is provided while avoiding provision of a larger quantity of further chemical product than storage space is available for at the consumption location.

In block 1016, the generated chemical product passport and/or the chemical product data is provided for access by decentral data consuming network node, this block being generally optional. The chemical product passport or the digital representation may be provided to a registry 908, such as described in the context of FIGS. 9 and 13. The decentral data consuming network node may use said passport to access the chemical product data associated with said passport, for example as described in the context of FIG. 9. The decentral data consuming network node may use said digital representation to access the chemical product passport or parts thereof associated with said digital representation, for example as described in the context of FIG. 9. The chemical product data or a part thereof may be provided for access under control of a decentral data providing network node associated with said chemical product data as described in the context of FIG. 9

FIG. 11A illustrates a flow chart of an aspect of block 1004 of FIG. 10 in accordance with an example embodiment of the present disclosure. The method illustrated in FIG. 11A may be performed in connection with sensor device(s) physically attached to the chemical product or a component thereof, such as the packaging unit comprising the chemical product. The sensor device(s) may be sensor device(s) 608 described in the context of FIGS. 6A to 6C. The method of FIG. 11A may be implemented by quantity monitoring unit 212 described in the context of FIGS. 6A to 6C.

In block 1102, data from one or more sensor device(s) associated with the chemical product may be gathered via a computing interface. The computing interface may be one or more communication interfaces allowing data exchange between the sensor device(s) and the computing node implementing the method of FIG. 11A (see for example FIG. 6B). The data may be gathered during storage of the chemical product within a product storage of the consumption location storing the chemical product. The data may be gathered during use of the chemical product within the plant of the consumption location to produce further chemical or discrete products. Use of sensor devices attached to packaging units containing the chemical product allows to monitor the consumption of the chemical product in real time. This allows to ensure that a sufficient amount of chemical product is always available at the consumption location since time delays during determination of the current amount of chemical product available at the consumption location are minimized.

The gathered data may include data being indicative of the quantity of the chemical product present within a respective packaging unit, such as the amount of chemical product present within the respective packaging unit. Data being indicative of the amount may include the fill level of the product within the respective packaging unit. Data being indicative of the amount may include acoustic signal(s) detected by the sensor device and being indicative of the amount (e.g. fill level). Data being indicative of the quantity of the chemical product may include data being indicative of whether the chemical product and hence the associated packaging unit has been used for production of further products. For instance, the gathered data may include an indicating that the chemical product present within said packaging unit has been consumed.

The sensor devices may be configured to acoustically stimulating the packaging unit to generate at least one audio signal being indicative of the fill level of the chemical product inside the packaging unit. The sensor devices may be configured to detect the generated audio signal(s) and to optionally process the detected audio signal(s). The detected or processed audio signals may be gathered by the computing node. The sensor device(s) may the sensor device comprise an actuator, at least one microphone, a computer processor, in particular a microprocessor, a data storage medium, at least one further sensor that detects the location and or movement of the packaging unit and at least one power supply. Processing the detected audio signal(s) may include digitally sampling the detected audio signal(s).

The data may be gathered from the sensor device(s) at predefined time intervals. The sensor device(s) may be configured to provide said data upon detecting a predefined trigger. For instance, the sensor device(s) may be configured to provide said data upon detecting movement of the packaging unit from the product storage to a production plant. This avoids unnecessary data transfer within the network and allows to prolong the service life of battery powered sensor device(s).

The data gathered from the sensor device may further include data being indicative of the consumption location. This ensures assignment of the data gathered from the sensor devices to the appropriate consumption location and hence allows to monitor the quantity of a chemical product at a plurality of different consumption locations.

In block 1104, data related to the remaining quantity of the chemical product may be determined using the gathered sensor device data. Data related to the remaining quantity of the chemical product at the consumption location may correspond to the sum of all the data being indicative of the quantity of the chemical product gathered from at least part of the sensor device(s). Determining the data related to the remaining quantity may include determining data being indicative of the amount of chemical product present within the respective packaging unit associated with a sensor device from which data has been gathered. Data related to the remaining quantity may include the remaining amount. The remaining amount may be given in volume or mass. Data related to the remaining amount may include a classifier, such as “empty” and “not empty”.

The data being indicative of the amount of chemical product present within the packaging unit may be determined based on data gathered from a sensor device attached to said packaging unit using different methods. One such method is described in published patent application WO 2022/233596 A1 and is outlined briefly hereinafter.

The method outlined in WO 2022/233596 A1 may include processing the gathered data. Processing may include aligning gathered data, such as audio sample(s), calculating a Fourier spectrum of the gathered data, optionally extracting at least one predefined feature from the calculated Fourier spectrum, and optionally combining the extracted features. Predefined features may include: frequency with the highest energy, (normalized) average frequency, (normalized) median frequency, the standard deviation of the frequency distribution, the skew of the frequency distribution, deviation of the frequency distribution from the average or median frequency in different Lp spaces, spectral flatness, (normalized) root-mean-square, fill-level specific audio coefficients, fundamental frequency computed by the yin algorithm, (normalized) spectral flux between two consecutive frames and any combinations thereof. The predefined features may be calculated from the spectrogram for each audio frame or the calculated magnitudes of frequency and phases of frequency or in the log-power domain using commonly known methods. The extracted features are combined by reducing the dimensionality of the predefined features using algorithms, such as the principal component analysis (PCA), known in the state of the art since calculation of the previously described features may result in data being too large for machine learning. In particular, the number of features may be reduced to less than 50 prior to performing machine learning. As combined features, the components of the PCA having the highest eigenvalues may be used. In another example, the predefined features are combined by aggregation of the extracted features.

The gathered or processed data may be provided to a data driven model parametrized on historical audio signals, historical fill levels of liquids and historical digital representations of containers to determine the fill level of the chemical product within the respective packaging unit. The data-driven model may provide a relationship between the fill level of the liquid in the container and the detected or processed audio signal(s) and is derived from historical audio signal(s), historical fill levels of liquids in containers and historical packaging unit data. The historical packaging unit data may comprise data on the size of the packaging unit, data on the content of the packaging unit, data on the initial filing level, data on the age of the packaging unit, data on the use cycle of the packaging unit and any combination thereof. The trained data driven-model may be selected from (i) deep learning algorithms, such as Long Short-Term Memory (LSTM) algorithms, Gated Recurrent Unit (GRU) algorithms or perceptron algorithms, (ii) instance-based algorithms, such as support vector machines (SVMs), (iii) regression algorithms, such as linear regression algorithms, or (iv) ensemble algorithms, such as gradient boosting machines (GBM), gradient boosting regression trees (GBRT), random forests or a combination thereof, in particular ensemble algorithms. The classifiers or regressors from different algorithms and audio samples may be stacked to obtain a higher accuracy.

Another method to determine the data being indicative of the amount of chemical product present within the packaging unit based on data gathered from a sensor device attached to said packaging unit is described in unpublished patent application EP23151905.9 and is outlined briefly hereinafter. The method described in EP23151905.9 may include determining a frequency spectrum, such as a Fourier spectrum, from the gathered data. The method may include determining at least one root mean square (RMS) value based on given time interval data, such as time interval data used to generate reference measurement data including RMS values for defined time interval data. One root mean square (RMS) value may be determined per time interval contained within the time interval data. Calculation of RMS values for specific time intervals allows to condense the information contained in the gathered data into a low number of values.

The determined RMS values may be compared with the reference measurement data. Reference measurement data may include RMS values for defined time intervals. The RMS values may be determined experimentally for different quantities and time intervals. The RMS values may be obtained by interpolation of RMS values determined experimentally. At least part of the reference root mean square (RMS) values contained in the reference measurement data may be associated with error data.

Comparing the determined RMS values with the reference data may include determining the arithmetic mean error and/or the mean square error of the determined RMS values to the reference measurement data. The remaining quantity may be determined by determining the defined amount (e.g. remaining quantity) associated with the lowest error, e.g. by determining the remaining quantity associated with the error minimum. The determined error(s) may be used to determine whether the accuracy of the determined remaining quantity is sufficient or not by comparing the determined error(s) to one or more predefined threshold value(s). The predefined threshold value(s) may be contained in the reference measurement data. If at least some of the error(s) is/are above one or more predefined threshold value(s), the accuracy may not be sufficient and the sensor device may be triggered to initiate a new measurement.

The data related to the remaining quantity as determined from the gathered data for at least part of the packaging units comprise a sensor device may be summed up to obtain data related to the remaining quantity of the chemical product present at the consumption location.

The data related to the remaining quantity may be associated with a chemical product identifier associated with the chemical product. This allows to associate the data related to the remaining quantity with a particular chemical product. The data related to the remaining quantity may be associated with a consumption location identifier. This allows to associate the data related to the remaining quantity with a particular consumption location.

In block 1106, the determined data related to remaining quantity may be compared to a predefined minimum threshold. The predefined minimum threshold may include data related to a minimum quantity of the chemical product to be present at the consumption location. The predefined minimum quantity may be associated with a particular consumption location. The predefined minimum quantity may be stored on a storage medium, such as a database, and may be gathered based on a consumption location identifier associated with the respective consumption location. The minimum quantity of the chemical product may be a quantity that may only allow production of further products from said chemical product at the consumption location for a defined time period. After that defined time period, the chemical product is no longer available at the consumption location. The minimum quantity may depend on the quantity of chemical product used at the consumption location and/or the frequency of use of the chemical product as previously described.

FIG. 11B illustrates a flow chart of an aspect of block 1004 of FIG. 10 in accordance with another example embodiment of the present disclosure. The method of FIG. 11B may be performed using production data of the consumption location. The method of FIG. 11B be implemented by quantity monitoring unit 212 described in the context of FIGS. 6A to 6C.

In block 1108, data related to the amount of chemical product consumed at the consumption location may be gathered via a computing interface. The gathered data may be summed up to obtain a total quantity of chemical product having been consumed at the consumption location. The gathered data may include the amount of consumed chemical product within a particular time interval. Such data may be gathered from a storage environment associated with the consumption location and accessible by the computing system implementing the method of FIG. 11. For instance, the operating system associated with the consumption location may be configured to gather data related to the amount of chemical product consumed within one or more plant(s) of the consumption location. Hence, the operating system may be configured to track inbound chemical product and associated amounts used during processes performed within said plant(s). The gathered data may be provided to the storage environment.

In block 1110, data related to the amount of chemical product provided to the consumption location may be gathered. Said data may be gathered by the operating system 208 associated with the chemical production 204 producing said chemical product 206 (see for example FIGS. 2A, 2B and 4). Based on a chemical product identifier and consumption location identifier included in the gathered data, the operating system 208 may be configured to gather the amounts of produced chemical product provided to said particular consumption location. Gathering amounts of produced chemical products may include mapping a chemical product identifier included in the gathered data to a chemical product identifier used within the chemical production 204 to identify chemical product 206. The amount of produced chemical product supplied to the respective consumption location may be gathered for a defined time interval associated with the supply of chemical product. The gathered data may be summed up to obtain a total quantity of chemical product supplied to the respective consumption location.

In block 1112, data related to the remaining quantity of the chemical product may be determined using the data gathered in blocks 1108 and 1110. Determining data related to the remaining quantity may include determining the difference between the data gathered in block 1108 (e.g. the quantity of supplied chemical product) and the data gathered in block 1110 (e.g. the quantity of consumed chemical product).

In block 1114, the determined data related to remaining quantity may be compared to a predefined minimum threshold, for example as described in the context of FIG. 11A.

FIG. 12 illustrates a flow chart of an aspect of block 1012 of FIG. 10 in accordance with an example embodiment of the present disclosure. The method described in FIG. 12 may be implemented using the system described in FIG. 13. The chemical product passport may be generated for a chemical product and may hence be associated with said chemical product. The chemical product may be chemical product 206 produced by chemical product 204 as described in the context of FIGS. 2A, 2B, 5A, 5B. The chemical product may be further chemical product produced by chemical product 204 as described in the context of FIG. 4.

The generated chemical product passport may include a decentral identifier and data related to chemical product data associated with the chemical product. Data related to the chemical product data may include one or more digital representation(s) pointing to the chemical product data or parts thereof. Hence, the generated chemical product passport may correspond to a digital access element enabling access to the associated chemical product data or parts thereof, for example as described in the context of FIG. 9. An example of a such a digital access element is the DID document illustrated in FIG. 7. Data related to the chemical product data may include the chemical product data or parts thereof. Hence, the generated chemical product passport may correspond to a digital twin of the chemical product.

In block 1202, a request to provide a decentral identifier associated with chemical product data of the produced chemical product and preferably a data owner may be received. The request may be received from a requestor, for example as described in the context of FIG. 13. The request may include data related to the chemical product data and/or an owner or product identifier associated with the chemical product data owner or the chemical product, respectively.

In block 1204, an authentication mechanism or scheme may be selected or provided, this block being generally optional. The authentication mechanism may be selected from a plurality of authentication mechanisms. The authentication mechanism may include a public-private key infrastructure. Through the authentication mechanism data access by a decentral data consuming network node can be controlled in a secure manner and integrity of the decentral data providing network node can be ensured. This allows for more reliable, controlled and secure data exchange or sharing.

In block 1206, chemical product data or a part thereof may be provided. Alternatively, digital representation(s) pointing to the chemical product data or a part thereof may be provided. The digital representation(s) may point to the dedicated storage storing the chemical product data or parts thereof, such as DT storage 922 described in the context of FIG. 9. The chemical product data may be provided from a storage environment storage chemical product data gathered for produced chemical product 206. The chemical product data may include the data mentioned in the context of FIG. 2A and FIG. 2B. Block 1206 may further include providing an owner identifier associated with the data owner of the chemical product data. This allows to associate data transactions involving the chemical product passport with the clear name of the data owner as previously described. Block 1206 may further include providing a chemical product identifier associated with the chemical product.

In block 1208, the chemical product passport may be generated. The generated chemical product passport may include the decentral identifier provided in response to the request received in block 1202 and the provided chemical product data or a part thereof. Alternatively, the generated chemical product passport may include the decentral identifier provided in response to the request received in block 1202 and the provided digital representation(s) pointing to the chemical product data or a part thereof. The generated chemical product passport may include the provided or selected authentication mechanism. The chemical product passport may further include an owner identifier and/or a chemical product identifier. Generating the chemical product passport may include providing one or more authorization mechanism(s) and associating the provided authorization mechanisms with the decentral identifier. Different authorization rule(s) may be associated with different classes of chemical product data to allow a more granular access to the chemical product data. For instance, a class containing emission data, recycled content data and bio-based content data may be associated with stricter authorization rule(s) than a class containing certificate of information data and/or chemical product safety data. Authorization mechanism(s) may include authorization rule(s) including data transaction instructions or data transaction protocols, such as data usage policies, smart data contracts or more complex data processing instructions associated with decentral data providing and/or decentral data consuming network nodes. Through the authorization mechanism(s) access and data usage of the chemical product data or parts thereof by a decentral data consuming network node can be controlled in a secure manner. The one or more authorization mechanism(s) may be provided to the decentral data providing network node associated with the chemical product passport, such as decentral data providing network node 924 described in the context of FIG. 9. A digital representation of the chemical product passport may be generated. The digital representation may include one or more representation(s) for accessing the chemical product passport or parts thereof, such as the chemical product data or parts thereof. The digital representation may be linked to the decentral identifier included in the chemical product passport. The digital representation may be used by data consuming network node(s) to access the chemical product passport or parts thereof, for example as described in the context of FIG. 9.

In block 1210, the decentral identifier included in the generated chemical product passport may be assigned to a physical identifier associated with chemical product. Assigning may include encoding the decentral identifier in a code physically attached to the chemical product or a component thereof, such as the packaging unit, for example as described in the context of FIG. 3. Assigning may be performed by an ID assignor, for example as described in the context of FIGS. 2A, 2B and 13.

FIG. 13 illustrates an example system and associated methods for generating a chemical product passport associated with a chemical product produced by a chemical production and providing access to the chemical product passport and/or the chemical product data associated with said chemical product passport. The apparatus for generating chemical product passport(s) may be included in operating system 208 of a chemical production 204 (see for example FIG. 2A). The apparatus for generating chemical product passports(s) may be communicatively coupled to the operating system 208 of a chemical production 204 (see for example FIG. 2B).

The chemical production 204 may produce at least one chemical product 206 from one or more inbound material(s) 202. The inbound materials may be provided to the chemical production 204, for example as described in the context of FIGS. 2A, 2B, 5A and 5B. The inbound materials may enter the system boundary of the chemical production 204 at the entry point, such as a production plant or a material storage associated with the chemical production 204. The inbound materials may be used in the chemical production 204 to produce one or more chemical product(s) from the inbound materials, for example as described in the context of FIGS. 2A, 2B, 5A and 5B. The operating system 208 of the chemical production 204 may monitor and/or control the chemical production 204 based on operating parameters of the different processes as described in the context of FIG. FIGS. 2A, and 2B.

The produced chemical products 206 may be provided at one or more exit points of the chemical production. The chemical product 206 may exit the system boundary 1304 of the chemical production 204. Upon producing the chemical product 206 or exiting of the chemical product 206 of the chemical production 204, the chemical product passport may be generated. The chemical product passport(s) may be generated by an apparatus for generating chemical product passport(s) 1302. The apparatus 1302 may be configured to generate the chemical product passport(s). The apparatus 1302 may be configured to receive a request to provide a decentral identifier associated with chemical product data of the produced chemical product and preferably a data owner. The apparatus 1302 may be configured to generate—in response to the received request—the chemical product passport(s).

A requestor 1306 may be configured generate the request to provide the decentral identifier. Said request may be triggered by a labelling system such as a QR Code generator. The request may include an owner identifier and/or a chemical product identifier as previously described. The request to provide the decentral identifier may be provided to a decentral ID generator 1314 configured to provide the decentral identifier. The decentral ID generator 1314 may be part of apparatus 1303. The decentral ID generator 1314 may be communicatively coupled to apparatus 1302, e.g. apparatus 1302 may not comprise said decentral ID generator 418 (not shown).

Decentral ID generator 1314 may be configured to generate the decentral identifier associated with the chemical product data and optionally a data owner, such a data owner of the chemical product data. Decentral ID generator 1314 may be configured to generate a decentral identifier including or being associated with further identifier, such as data set identifier(s) associated with different classes of chemical product data. For instance, decentral ID generator 1314 may be configured to generate a decentral identifier, such as a DID or a UUID. Decentral ID generator 1314 may be configured to generate data set identifier(s), such as DID(s) and/or UUID(s). Decentral ID generator 1314 may comprise a component configured to generate Decentralized Identifier(s) (DID(s)). Decentral ID generator 1314 may comprise a component configured to generated Universally Unique Identifiers (UUID(s)). The decentral identifier generated by decentral ID generator 1314 may be one or more DID(s) and/or UUID(s). The one or more DID(s) and/or UUID(s) may be associated with the chemical product data or parts thereof, such as data set(s). The one or more DID(s) and/or UUID(s) may further be associated with the chemical product. For instance, the decentral identifier may include a decentral identifier associated with the chemical product data and one or more data set identifier(s) associated with different classes of chemical product data. The decentral identifier may further include a chemical product identifier associated with the chemical product. Decentral ID generator 1314 may be a central or decentral network node. Decentral ID generator 1314 may be computing node that acts as a DID owner's management module, user agent, ID hub and/or certification issuer. The decentral ID generator 1314 may be configured to provide the generated decentral identifier to a decentral ID provider 1308. The decentral ID generator 1314 and the decentral ID provider 1308 may be separate devices as illustrated in FIG. 13. The decentral ID generator 1314 and the decentral ID provider 1308 may be contained within one device configured to generate the decentral identifier and to provide the generated decentral identifier (not shown).

Decentral ID provider 1308 may provide the generated decentral identifier to the requestor 1306. The requestor 1306 may be configured to associate or link the received decentral identifier with the produced chemical product. The requestor 1306 may hence contain an ID assignor configured to assign the decentral identifier to a physical identifier. Such association may include encoding the decentral identifier into a code, such as a bar code, QR code, embossed code, optical holographic code, or a tag, such as an RFID tag, and providing the code or tag for labelling the chemical product. This way a physical identifier may be provided that relates the physical entity of the chemical product with the decentral identifier received from decentral ID provider 1308. Since the physical identifier is associated with the chemical product and its virtual digital chemical product passport, the chemical product can be provided in association with the chemical product passport which in turn allows access to the associated or included chemical product data or a part thereof associated with said chemical product. The chemical product associated with the physical identifier may hence be provided physically and the chemical product passport and chemical product data or a part thereof associated with the physical identifier may be provided virtually.

The decentral ID provider 1308 may provide the decentral identifier to chemical product passport generator 1310 configured to generate the chemical product passport based on the decentral identifier received from decentral ID provider 1308 and data related to the chemical product data. The chemical product passport generator 1310 may generate the chemical product passport as described for example in the context of FIG. 12. The chemical product passport may include the decentral identifier and the data related to the chemical product data. Data related to the chemical product data may include digital representation(s) pointing to the chemical product data or a part thereof. Said representation may include the endpoint address of the decentral data providing network node associated with the chemical product data or a part thereof (i.e. the decentral data providing network node 924 associated with the respective digital twin storage 922 in FIG. 9). Use of the endpoint address of the decentral data providing network node allows to avoid disclosure of the internal endpoint address to the digital twin (DT) storage 922, thus improving the security and avoiding unintended access or leakage of the digital twin or a part thereof. Data related to the chemical product data may include the chemical product data or parts thereof. The chemical product data may be gathered by the chemical production 204 and may be stored in one or more databases associated with the chemical production 204. The chemical product passport may include or be related to one or more authentication mechanisms associated with the decentral identifier and/or the data related to the chemical product data as described in the context of FIG. 12. The chemical product passport may relate to one or more authorization mechanisms associated with the decentral identifier and/or the data related to the chemical product data as described in the context of FIG. 12.

The generated chemical product passport may be provided to a digital twin (DT) storage 922. This allows to store the generated chemical product passport and hence avoids regeneration of the chemical product passport.

Chemical product passport generator 1310 may further be configured to generate a digital representation of the chemical product passport. The digital representation may include one or more representation(s), such as locator(s) or pointer(s), for accessing the chemical product passport or parts thereof, such as the chemical product data or parts thereof. The digital representation may be linked to the decentral identifier included in the chemical product passport.

The generated chemical product passport or digital representation may be provided to decentral data providing network node 924. The generated chemical product passport or digital representation may be provided registry 908. Registry 908 may be part of a decentral network 1312. Registry 908 may be configured to store digital chemical product passport(s) or digital representation(s) and may serve as a central or decentral repository for existing chemical product passports or digital representation(s). For instance, registry 908 may store decentral identifiers and associated digital representation(s). Registry 908 may be available to the public, hence allowing transparency on existing chemical product passports and associated chemical product data of chemical products. However, access to the chemical product data or parts thereof associated with said chemical product passports may be controlled by the data owner of the chemical product passport(s), for example by using decentral data providing network node 924 implementing appropriate authentication and authorization schemes. This allows to retrain the control of access and use of chemical product data with the data owner while at the same time allowing transparency on available chemical product passport(s) and associated chemical product data.

Decentral data consuming network node(s) 912 may have access to the registry 908 and may retrieve digital representation(s) based on decentral identifier(s), for example as described in the context of FIG. 9. The decentral data consuming network node(s) 912 may be part of a decentral network 1312. The decentral data consuming network node(s) 912 may be associated with the chemical product consumer, for example as described in the context of FIG. 9. This allows transfer of or access to the digital twin or a part thereof in a controlled and secure manner.

Decentral data providing network node 924 may be configured to provide the chemical product data or a part thereof for access by a decentral data consuming network node 912. Decentral data providing network node 924 may be configured to provide the chemical product data or the part thereof based on a decentral identifier and optionally data set identifier(s) received from the decentral data consuming network node 912, for example as described in the context of FIG. 9. Decentral data providing network node 924 may control the access to the chemical product data or the part thereof by the decentral data consuming network node 912. Decentral data providing network node 924 may be a decentral data providing network node associated with the chemical production 204. Decentral data providing network node 924 be associated with or under control of a data owner of the digital twin.

The described system and associated method allow to generate chemical product passports associated with chemical products. The generated chemical product passports allow a simplified and customizable data sharing or exchange of chemical product data associated with the produced chemical product from chemical industry to chemical supply chain participants.

The present disclosure has been described in conjunction with preferred embodiments and examples as well. However, other variations can be understood and effected by those persons skilled in the art and practicing the claimed invention, from the studies of the drawings, this disclosure and the claims. Notably, in particular, the any steps presented can be performed in any order, i.e. the present invention is not limited to a specific order of these steps. Moreover, it is also not required that the different steps are performed at a certain place or at one node of a distributed system, i.e. each of the steps may be performed at different nodes using different equipment/data processing.

As used herein “determining” also includes “initiating or causing to determine”, “generating” also includes “initiating and/or causing to generate” and “providing” also includes “initiating or causing to determine, generate, select, send and/or receive”. “Initiating or causing to perform an action” includes any processing signal that triggers a computing node or device to perform the respective action.

In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

Any disclosure and embodiments described herein relate to the methods, the systems, devices, the computer program element lined out above and vice versa. Advantageously, the benefits provided by any of the embodiments and examples equally apply to all other embodiments and examples and vice versa.

All terms and definitions used herein are understood broadly and have their general meaning.

1. A method for controlling the production of a chemical product by a chemical production, said method comprising:
(a) producing the chemical product from one or more inbound materials using the chemical production and providing the produced chemical product to a consumption location,
(b) gathering data being indicative of the quantity of the chemical product at the consumption location and comparing the gathered data to a predefined minimum threshold,
(c) in accordance with the determination that the gathered data being indicative of the quantity of the chemical product has reached or has fallen below the predefined minimum threshold, triggering production of further chemical product,
(d) receiving a request to provide a decentral identifier associated with chemical product data of the produced further chemical product and optionally a data owner, and
(e) in response to the request, generating a chemical product passport including the decentral identifier and data related to the chemical product data and assigning a physical identifier connected to the produced further product to the decentral identifier.

2. The method of claim 1, wherein a defined quantity of chemical product is provided to the consumption location.

3. The method of claim 1, wherein providing the produced chemical product to the consumption location includes feeding the produced chemical product into a product storage of the consumption location or feeding the produced chemical product into a plant associated with the consumption location.

4. The method of claim 1, wherein the quantity of the chemical product at the consumption location is monitored via at least one sensor device.

5. The method of claim 1, wherein gathering data being indicative of the quantity of the chemical product at the consumption location includes
gathering via a computing interface data from one or more sensor device(s) associated with the chemical product, said data including data related to the current quantity of the respective chemical product and a chemical product identifier associated with the respective chemical product, and
determining data related to the remaining quantity of the chemical product using the gathered sensor device data.

6. The method of claim 1, wherein gathering data being indicative of the quantity of the chemical product at the consumption location includes
gathering via a computing interface data related to the amount of chemical product consumed at the consumption location,
gathering via a computing interface data related to the amount of chemical product provided to the consumption location, and
determining data related to the remaining quantity of the chemical product using the received data.

7. The method of claim 1, wherein the predefined minimum threshold includes data related to a minimum quantity of the chemical product.

8. The method of claim 1, wherein triggering production of further chemical product includes generating chemical production data and producing further chemical product using the generated chemical production data.

9. The method of claim 1, wherein the generation of the chemical product passport includes providing the decentral identifier associated with a physical entity of the chemical product.

10. The method of claim 1, wherein the data related to chemical product data includes one or more digital representation(s) pointing to the chemical product data or parts thereof.

11. The method of claim 1, wherein the data related to the chemical product data includes chemical product data or parts thereof.

12. The method of claim 1, wherein the chemical product data further comprises data related to a property of the further chemical product and/or data related to the use of the further chemical product.

13. The method of claim 1, further including a step of providing the chemical product data associated with the produced further chemical product and/or the generated chemical product passport for access by a decentral data consuming network node, said access being controlled by a decentral data providing network node associated with the data owner of the chemical product data.

14. An apparatus for controlling the production of a chemical product by a chemical production, the apparatus comprising:
a chemical production configured to produce the chemical product and the further chemical product from the one or inbound more material(s) and to provide the produced chemical product and further chemical product to a consumption location,
a monitoring unit configured to gather data being indicative of the quantity of the chemical product at the consumption location and to compare the gathered data to a predefined minimum threshold,
a triggering unit configured to trigger the production of further chemical product if the gathered data being indicative of the quantity of the chemical product has reached or has fallen below the predefined minimum threshold,
a collector configured to collect chemical product data associated with the further chemical product,
a chemical product passport generator configured to generate a chemical product passport by receiving a request to provide at least the decentral identifier linked to chemical product data associated with the further chemical product and in response to the request, generate the chemical product passport including the decentral identifier and data related to the chemical product data associated with the further chemical product, and
an assignor configured to assign a physical identifier connected to the produced further chemical product to the decentral identifier included in the generated chemical product passport associated with the produced further chemical product.

15. A computer element with instructions, which when executed on one or more computing node(s) are configured to carry out the steps of the method as claimed in any one of claims 1 to 12 claim 1.

16. A computer element with instructions, which when executed on one or more computing node(s) are configured to be carried out by the apparatus as claimed in claim 14.
